(19) United States
(12) Patent Application Publication
(10) Pub. No.: US 2013/0281190 A1
(43) Pub. Date: Oct. 24, 2013

(54) Game Play System for Automated Terminals

(71) Applicant: LINQ3 TECHNOLOGIES LLC, New York, NY (US)

(72) Inventors: Daniel Cage, New York, NY (US); Roy Leach, Elizabeth, CO (US)

(73) Assignee: LINQ3 TECHNOLOGIES LLC, New York, NY (US)

(21) Appl. No.: 13/839,558

(22) Filed: Mar. 15, 2013

Related U.S. Application Data
(63) Continuation of application No. 13/280,196, filed on Oct. 24, 2011.
Application No. 13/280,196 is a continuation-in-part of application No. 11/734,207, filed on Apr. 11, 2007.
(60) Provisional application No. 60/886,818, filed on Jan. 26, 2007.

(51) Int. Cl. G07F 17/32

(52) U.S. Cl. CPC G07F 17/3244
USPC 463/25

(57) ABSTRACT

Disclosed embodiments relate to various aspects of providing game play. Exemplary embodiments of systems and methods allow for game play on a variety of unmanned terminals including, but not limited to, automated teller machines, taxi cab payment systems, fuel pump payment interfaces, a variety of other kiosks, and handheld devices. In an embodiment, a disclosed device allows for exchanging communications between a gaming facilitator and a gaming partner.

### CROSS-REFERENCE TO RELATED APPLICATIONS

This application is a continuation of U.S. application Ser. No. 13/280,196, entitled “Game Play System for Automated Terminals,” filed on Oct. 24, 2011, which is a continuation-in-part of U.S. Application. No. 11/734,207, filed Apr. 11, 2007, entitled “Systems and methods for providing lottery game play through an unmanned terminal,” which claims priority to U.S. Provisional Application No. 60/886,818, filed Jan. 26, 2007, entitled “Systems and Methods for Integrating ATM and Lottery Functions,” each of which is incorporated herein by reference in its entirety.

### TECHNICAL FIELD

This disclosure generally relates to game play systems for automated terminals, and, more specifically, this disclosure relates to a system for providing cashless lottery type game play on a variety of unmanned terminals including, but not limited to, automated teller machines, taxi cab payment systems, fuel pump payment interfaces, a variety of other kiosks, point-of-sale systems, and handheld devices.

### BACKGROUND

Many governments have passed laws permitting lottery games to be legalized within their borders. These laws are due to the enormous public support for this style of entertainment. Currently, these games are presented through specific manned terminals which connect to lottery operators—corporations responsible for running the lottery games. While these games have proven to be extremely popular, a large segment of the population does not participate. This is due to many factors including a lack of understanding of how to play, a lack of desire to interact with personnel running the game kiosks, the belief that only a few people win these games, the inconvenience of the manned terminals, the concern over losing a ticket, and, more recently, the lack of cash to play the games as many people are only using payment cards for purchases these days.

### SUMMARY

According to one embodiment, the disclosed system may comprise a device for exchanging communications between a gaming facilitator and a gaming partner, the device comprising a translation module operable to translate the communications from a first communication protocol into a second communications protocol; an encryption module operable to encrypt the communications; a memory module; and a central processing unit module for processing the communications exchange; wherein the translation module, the encryption module, the memory module, and the central processing unit module are communicatively connected.

According to another embodiment, the disclosed system may comprise a system for registering automated gaming transaction service user information, the system comprising a storage module for storing user records having user information for registered users of the automated gaming transaction service, a processor module in communication with the storage module, the processor module being programmed for processing one or more of automated gaming transaction service registration processes, user game play history inquiry processes, user favorite number inquiry processes, user notification processes, and user interface processes; and a program memory module in communication with the processor module.

According to another embodiment, the disclosed system may utilize a method for registering automated gaming transaction service user information, including the following steps: comprising receiving user information for a registered user of the automated gaming transaction service, processing a registry function based on the received user information, the registry function comprising one or more of processing automated gaming transaction service registration information, processing a user game play history inquiry, processing a user favorite number inquiry, processing a user notification, and processing a user interface function.

According to another embodiment, the disclosed system may comprise a gaming provider system comprising a host comprising an application logic and at least one terminal in communication with the host, wherein the application logic is operable to provide instruction for routing a financial transaction outside of the gaming provider system, the financial transaction being initiated through the at least one terminal.

According to another embodiment, the disclosed system may utilize a method for identifying win information for game plays associated with an automated gaming transaction service, the method comprising: connecting with a game play operator, receiving game play win information from the game play operator, and storing the game play win information in a database.

According to another embodiment, the disclosed system may utilize a method for detecting a winning game play at an automated gaming transaction service, the method comprising: determining a game identifier of an item game stored in a database, the game identifier associated with a first game; comparing game play win information for the first game with game play information associated with the game identifier, wherein the game play win information is stored in a second database and originated from a game play authority associated with the first game; determining whether the game play information is a win; and updating the item game with one of win or lose information.

According to another embodiment, the disclosed system may utilize a method for verifying game play outcomes for a customer of an automated gaming transaction service comprising: inputting customer information associated with the customer; encrypting the customer information; sending the encrypted customer information to the automated gaming transaction service; receiving a response from the automated gaming transaction service, the response including prize information, wherein the prize information includes any outstanding prizes associated with the customer; and determining whether to process a prize payment for the customer.

These and other advantages of the present disclosure will become apparent to those skilled in the art from the following detailed description, the accompanying drawings, and the appended claims.

### BRIEF DESCRIPTION OF THE DRAWINGS

FIG. 1 is a schematic diagram illustrating a game play system, in accordance with the present disclosure;

FIG. 2A is a schematic diagram illustrating a communications exchange server, in accordance with the present disclosure;

FIG. 2B is a schematic diagram illustrating a communications exchange server, in accordance with the present disclosure;

FIG. 3 is a schematic diagram illustrating a gaming facilitator registration system, in accordance with the present disclosure;

FIG. 4 is a flow diagram illustrating a process for a game play, in accordance with the present disclosure;

FIGS. 5A, 5B, and 5C are schematic diagrams illustrating terminal configurations, in accordance with the present disclosure;

FIGS. 6A and 6B are schematic diagrams illustrating systems including gaming partners having multiple types of connectivity terminals, in accordance with the present disclosure;

FIGS. 7A and 7B are schematic diagrams illustrating systems with gaming partners using a substantially direct communication to their terminals, in accordance with the present disclosure;

FIGS. 8A and 8B are schematic diagrams illustrating a system with a gaming partner using a wireless communication connection to their terminals, in accordance with the present disclosure;

FIGS. 9A and 9B are schematic diagrams illustrating a system with a gaming partner using a network connection to their terminals, in accordance with the present disclosure;

FIGS. 10A, 10B, and 10C are flow diagrams illustrating a process for a terminal-based play of an automated lottery system presented game, in accordance with the present disclosure;

FIGS. 11A, 11B, and 11C are flow diagrams illustrating a process for a host-based play and terminal-based play where the terminal has a substantially constant connection of an automated lottery system presented game, in accordance with the present disclosure;

FIG. 12 is a flow diagram illustrating an automated process for determining winning tickets, in accordance with the present disclosure;

FIGS. 13A, 13B, and 13C are flow diagrams illustrating various automated processes for detecting winning tickets, in accordance with the present disclosure;

FIG. 14 is a flow diagram illustrating a process for winner verification 1300 involving a State Lottery Commission, in accordance with the present disclosure;

FIG. 15 is a schematic diagram illustrating a gaming facilitator system, in accordance with the present disclosure; and

FIG. 16 is a schematic diagram illustrating a gaming facilitator system, in accordance with the present disclosure.

### DETAILED DESCRIPTION

The disclosed systems and methods make lottery games accessible to a larger segment of the population by providing a cashless solution that is available on automated terminal devices including, but not limited to, automated teller machines, taxi cab payment systems, a variety of other kiosks, and handheld devices.

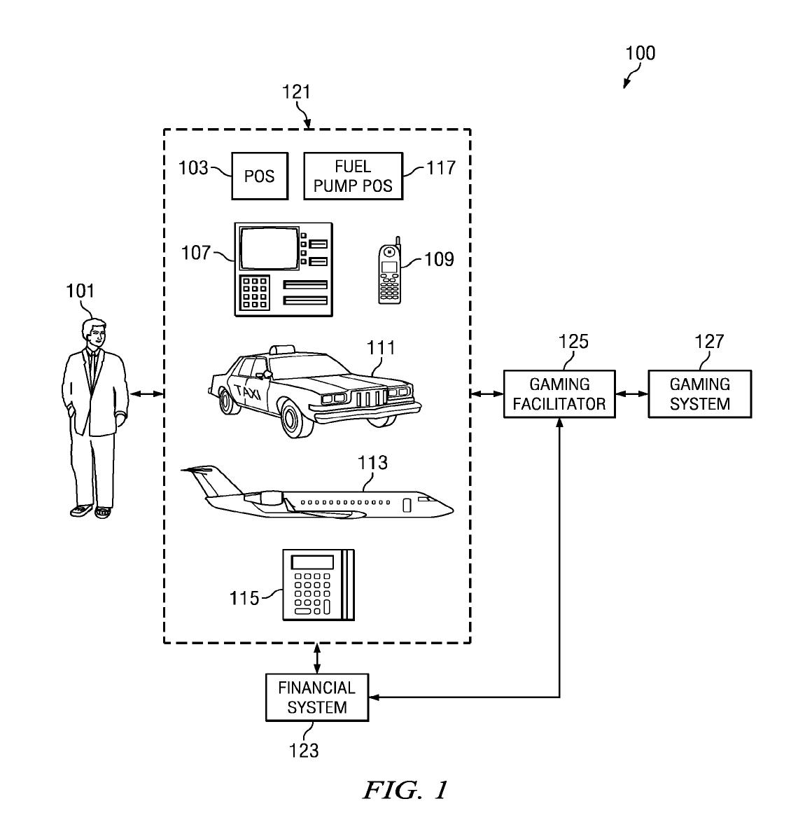

FIG. 1 is a schematic diagram illustrating automated lottery systems 100. A user 101 may interact with a variety of devices 121. These devices 121 are already familiar to users 101 and present a non-threatening interface to lottery games. By way of example only, devices 121 may include an unmanned point of sale terminal 103, an automated teller machine (ATM) 107, a mobile device 109, a taxi cab screen payment interface 111, an airplane screen payment interface 113, an unmanned payment kiosk 115, and/or a fuel pump payment interface 117. These devices may be in communication with a financial system 123 directly and/or through a gaming facilitator 125. The financial system 123 may include, but is not limited to, payment processors, issuer banks, acquirer banks, payment rails, credit networks, etc. A gaming system 127 may also be in communication with the gaming facilitator 125. The gaming system 127 may include, but is not limited to, a gaming authority, a gaming operator (for example, state lottery operators), a gaming commission (for example, a state lottery commission), etc. The disclosed system 100 and methods reduce reliance on retaining control over a paper ticket, as most prizes are automatically deposited into the player's bank account.

### Communications Exchange Server

To achieve the goal of selling lottery tickets through point of sale devices, a communication network is used for communications between a gaming facilitator and gaming partners. This communication network is designed to be secure, reliable, and fast. In an embodiment, each gaming partner may have their own protocol for communicating with and between their systems, servers, and remote devices. Some gaming partners utilize public protocols (e.g., ISO8583) while other gaming partners have generated their own proprietary protocols. To ensure the security of each partner's data and protocols, a server for exchanging communications between a gaming facilitator and a gaming partner may be used.

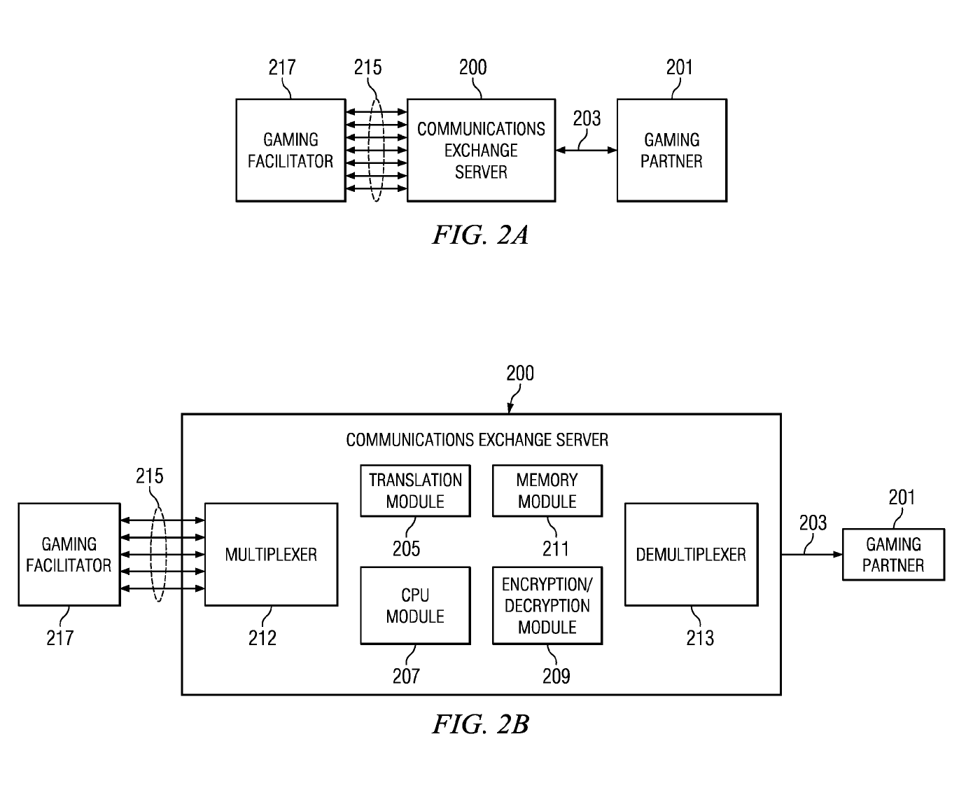

FIG. 2A is a schematic diagram of a communications exchange server 200 for exchanging communications between a gaming facilitator 217 and a gaming partner 201. The communications 203, 215 may include transaction-specific gaming information. In some embodiments, the communications exchange server 200 is an inbound communications server (as shown) for receiving and sending communications at a gaming facilitator 217 to and from a gaming partner 201. The communications 215 between the gaming facilitator 217 and the communications exchange server 200 are multiple connections which represents a series of parallel requests. The communications 203 between the communications exchange server 200 and the gaming partner 201 are a single connection which represents a series of serialized requests. In those embodiments, the communications exchange server may be located at the gaming facilitator.

In some embodiments, the communications exchange server 200 is an outbound communications server (not shown) for receiving and sending communications at a gaming facilitator 217 to and from a gaming partner 201. The communications between the gaming facilitator 217 and the communications exchange server 200 are a single connection which represents a series of serial requests. The communications between the communications exchange server 200 and the gaming partner 201 are multiple connections which represent a series of parallel requests. In those embodiments, the communications exchange server may be located at a gaming partner's site, for example, at a Lottery Operator. A gaming facilitator may send a single request to a communications exchange server that a Lottery Operator send a number of tickets (e.g., “give me 20 tickets”). The communications exchange server may turn that request into a number of requests for one ticket (e.g., 20 requests of, “give me one ticket”), resulting in a number of tickets (e.g., 20 tickets) being generated.

FIG. 2B is a more detailed schematic diagram of a communications exchange server 200 for exchanging communications between a gaming facilitator 217 and a gaming partner 201. The device 200 may include a translation module 205, encryption and decryption module 209, memory module 211, processing (CPU) module 207, multiplexer 212, and demultiplexer 213. The translation module 205 may translate communications between a gaming facilitator 217 and a gaming partner 201 by translating between a communication protocol used by the gaming partner 201 (e.g., a proprietary format of the gaming partner 201) and a communication protocol used by the gaming facilitator 217 (e.g., a proprietary format of the gaming facilitator 217). The encryption and decryption module 209 may encrypt and/or decrypt communications 215 between the gaming facilitator 217 and gaming partner 201. For example, data arriving at connection 215 from the gaming facilitator 217 may be encrypted. The encryption and decryption module 209 may decrypt the data such that it can be processed by the communications exchange server at the processor 207. Encryption keys may be used and may be updated at arbitrary times. Further, it may be desired that outgoing data at connection 215 to the gaming facilitator 217 or at connection 203 to the gaming partner 201 be encrypted before it is sent. Accordingly, the encryption and decryption module 209 may encrypt the data according to encryption protocols used by the gaming partner 201 and/or gaming facilitator 217. The memory module 211 may store information from the communications 203, 215 between the gaming facilitator 217 and gaming partner 201. The memory module 211 may also store gaming information. In an embodiment, the memory module 211 is a cache for storing gaming information and Bank Information. The cache 211 may store non-transaction specific gaming information. The cache 211 may also store game-related logic or a portion of game-related logic. The memory module 211 may also be program memory including logic or instructions accessible by the processor module 207. The processing module 207 may process the communications 203, 215 between the gaming partner 201 and the gaming facilitator 217. The translation module 205, encryption and decryption module 209, memory module 211, and processing module 207 are communicatively connected.

As discussed above, the communications exchange server 200 may be considered as an inbound or an outbound communications server. Inbound communications at connection 215, from one or more gaming partners 201 to gaming facilitator 217 may be multiplexed by the multiplexer 212. Outbound communications at connection 203 from the gaming facilitator 217 to the one or more gaming partners 201 may be demultiplexed by the demultiplexer 213.

FIG. 2B depicts a single translation module 205, memory module 211, CPU module 207, encryption and decryption module 209, and communications exchange server 200 for simplicity purposes only. At any point of connection between a gaming facilitator 217 and a gaming partner 201, multiple communications exchange servers 200 may be used for a variety of reasons including, but not limited to, redundancy, speed or efficiency of the system, failure diagnostics, ease of system upgradeability, system back-ups, network monitoring, etc. Further, each communications exchange server 200 may include multiple of any modules in the server 200. For example, in some embodiments, the communications exchange server 200 includes multiple memory modules 211 and multiple CPU modules 207. The communications exchange server 200 may be made of one or more machines, one or more motherboards, one or more memory modules, etc.

In an embodiment, the communications exchange server 200 is a computer that translates the gaming partner's communication protocol into a gaming facilitator specific protocol, thereby substantially eliminating the exposure of the partner's protocol to an outside entity. A communications exchange server 200 may be placed at a gaming partner's data center, either inside or outside of the gaming partner's firewall depending upon a gaming partner's preference. The communications exchange server 200 connects to gaming facilitator data centers over a gaming facilitator provided connection. In an embodiment, the gaming facilitator provided connection is a high speed, private connection (e.g., an MPLS connection). While this type of connection provides some inherent security, communications to and from the gaming facilitator may be encrypted to provide an additional layer of protection.

Non-transaction specific information (images, game rules, game information, etc.) may be cached on the device 200 in memory module 211, which allows for rapid access to cached data. For transaction specific information, data may be passed from the gaming partner 201 to the communications exchange server 200 which then encrypts the data and passes the request to a gaming facilitator 217 via a gaming facilitator provided connection.

The communications exchange server 200 may be used with a variety of gaming partners 201 including, but not limited to, lottery authorities, banking systems, and other payment systems. Further, the communications exchange server 200 may be located at a gaming partner location or at a gaming facilitator location.

### User Registration

In an embodiment, a gaming facilitator system may include a user registration server. The user registration server allows users to register with the gaming facilitator system. Registering may allow users to check to see their play history, set spending limits, to select favorite numbers to be played, and to configure how they wish to be notified of their play status. In an embodiment, users may have an online account with the gaming facilitator system in which they may register, configure and make selections for their account with the gaming facilitator system.

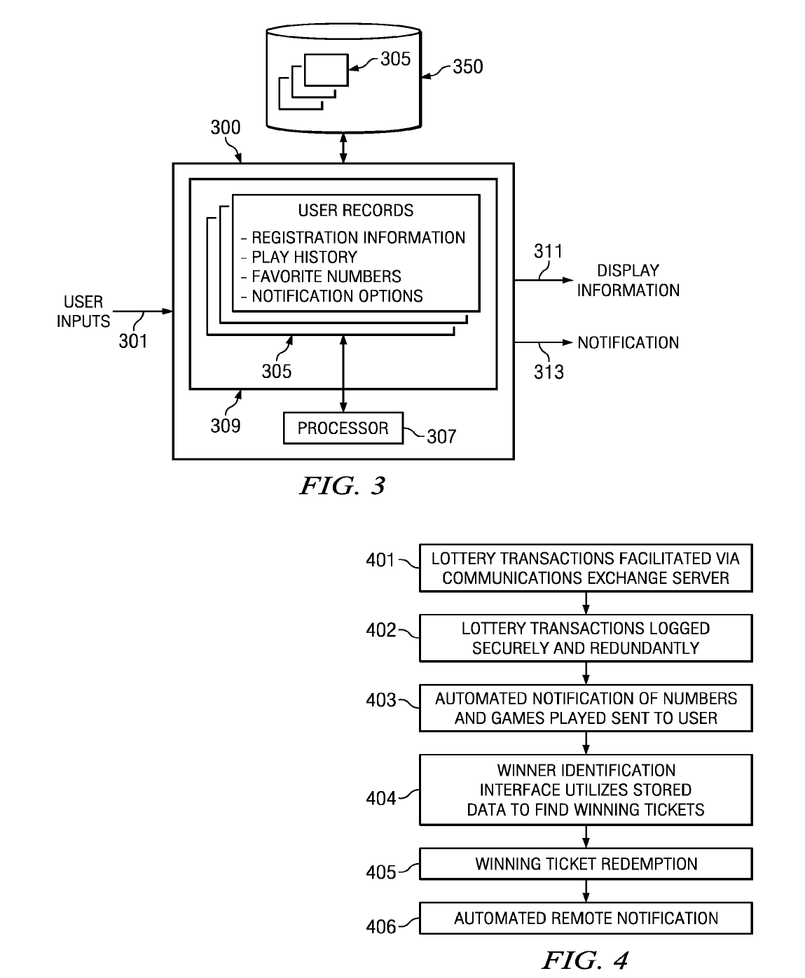

FIG. 3 is a schematic diagram of a representative user registration server 300. The server 300 includes user records 305, which may include user registration information, play history information, favorite numbers, and notification options. The records 305 may be stored in a database 350 and may be accessed and temporarily stored in memory 309 in the registration server 300 when used. The server 300 also may include a processor 307 in communication with memory 309. In an embodiment, the registration server 300 may actually be a set of networked servers, but is shown in FIG. 3 as a single server for illustration purposes only. Similarly, the processor 307 may be a plurality of processors or computers, memory 309 may be a plurality of memory elements, and database 350 may be a plurality of database elements. The server 300, processor 307, memory 309, and database 350 may be implemented using a distributed computing environment or cloud computing environment.

Users may input information 301 to the user registration server 300. User input information may include, but is not limited to, user identifying information or other registration information including an address, phone number, social security number, e-mail address, etc.; favorite number information; game play information; and notification option selections. User information may be entered a personal computer, hand-held device, or any device used with the automated lottery system including, but not limited to, an unmanned point of sale terminal, a VeriFone device, an automated teller machine (ATM), a taxi cab screen payment interface, an airplane screen payment interface, a fuel pump interface, or an unmanned payment kiosk.

The user registration server 300 may output display information 311. Display information 311 may include, but is not limited to, favorite number information, user information, registration information, game play information, notification options, labels for numbers, randomly generated numbers, notification option selections, and other player preferences. For example, the user registration server 300 may supply display information 311 to a user's personal computer while a user registers or configures their account. Alternatively, the user registration server 300 may supply display information 311 to a device used with the automated lottery system (e.g., an ATM).

The user registration server 300 may also output notifications 313. Notifications 313 may include, but are not limited to, a notification that a user won, a notification that a user won a certain amount of money, a notification that a user did not win, a notification that a game is available, a notification about game statistics, a notification about winning statistics, notifying them when a user wins, what the winning numbers were if a user loses, what the current jackpot is, etc. The user registration server 300 may supply the notifications to a user's hand held device, mobile provider, e-mail service, or any other type of personal communication service. This notification information can be sent to a cell phone via text messages, to email accounts, to an RSS feed, to social web sites such as Twitter and Facebook, or through device specific apps (i.e. iPhone, BlackBerry, or PDA apps) and of course, through automated lottery system web sites. Registered users can select a variety of notification options which the automated lottery system uses to inform the user of their play status. Registered users can see a history of their play and can have it sent through a variety of notification channels. This will allow them to see how often they play, what numbers they played, whether the numbers were automatically generated or if they were one of the player's “Favorite Numbers”.

### Play Overview

FIG. 4 is a high-level flow diagram illustrating a process for an automated lottery system transaction. At action 401, a communication exchange server facilitates lottery transactions from stationary or mobile automated transaction terminals via the use of payment cards (e.g., debit, credit, or smart cards). The transaction includes authorization through the network, obtaining ticket information, and distributing the particular information (e.g., numbers, security keys, etc.) for a specific lottery transaction back to the terminal.

At action 402, the transaction is logged securely in multiple redundant data centers including information such as time-stamps, terminal IDs, transaction IDs, encrypted track data from a user card, game IDs, numbers, and batch played.

At action 403, automated paperless receipts are provided to indicate numbers and games played. This notification may be sent via multiple methodologies including email, wireless delivery to mobile devices utilizing SMS text or device specific applications, RSS feed, or feeds into Twitter, Facebook or other social media accounts.

At action 404, a winner identification interface utilizes the stored transaction data. This interface utilizes the data to query data from the lottery operator to find winning ticket numbers. The data may be separated into three categories: non-winning tickets, winning tickets available for auto-redemption, and winning tickets available for manual claims. An additional winner verification system that a lottery facilitator may provide may be used by a game administrator to verify the integrity of tickets and to validate that a presented ticket is a winner for items that are manually claimed.

At action 405, auto-deposit for winning tickets through a point of sale terminal, debit, and/or credit network allows for redemption of winning tickets under a taxable or manually verifiable limit via a pin-less debit card or credit card transaction. A unique terminal number may be used for this transaction, and a pin or card may or may not be used for completion of the transaction.

At action 406, automated remote notification may be sent to a user indicating play status (winner, winner with manual redemption, non-winner, winning numbers, game jackpots, and other statistics). Notifications may be sent via wireless delivery to a mobile device or email address using SMS text, email or RSS feed to Twitter, Facebook or other social media account.

### Application Logic

Automated lottery system logic may reside at a device associated with the automated lottery system (e.g., ATM, POS terminal, mobile device, etc.), at a host associated with the device, or both at the device and the host.

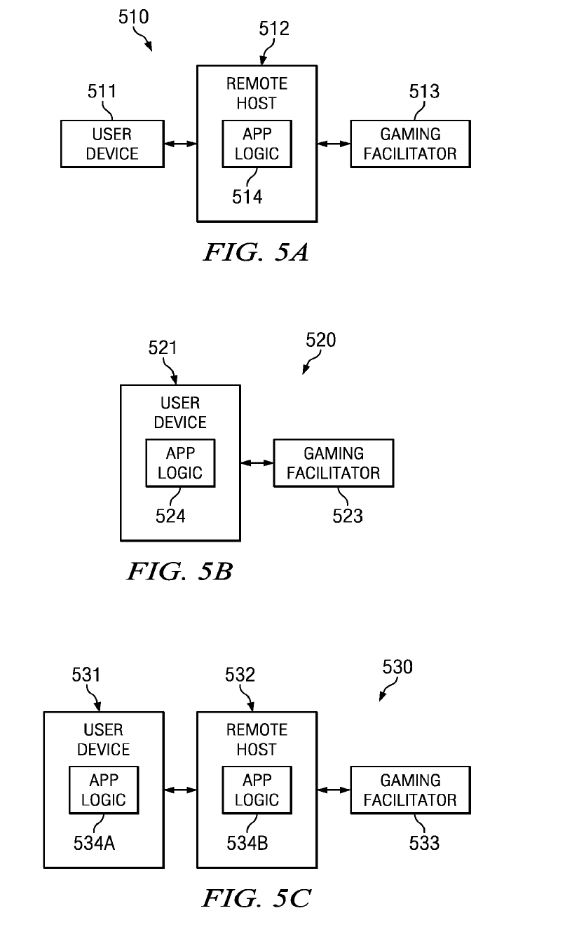

FIG. 5A is a schematic diagram illustrating a host-based input system 510. With the host-based terminal 510, the user device 511 is simply a user input/display device. The application logic 514 that determines what happens with each input and provides decision-making for what to display to the user occurs on a remote host 512. The host 512 contains automated lottery system logic and may gather the user input by providing the appropriate screens to the user device 511 and forwarding the user input to the gaming facilitator 513 either through an intermediary communications exchange server (not shown) or to the gaming facilitator directly.

FIG. 5B is a schematic diagram illustrating a terminal-based input system 520. Terminal-based input systems have automated lottery system application logic 524 on the user device 521. Accordingly, the user device 521 has the ability to walk a user through the game process and may then send the information that the user has selected to a gaming facilitator 523 either through an intermediary communications exchange server (not shown) or to the gaming facilitator directly.

FIG. 5C is a schematic diagram illustrating a hybrid-based input system 530. Hybrid-based input systems have some application logic 534A stored at the user input device 531 to gather user input and display the game specific parameters, but also rely on some application logic 534B stored at a remote host 532 to control the automated lottery system flow. An example of this is a cell phone with an automated lottery system application where the application on the phone controls the layout of the screen, receives user input, and performs basic validation (e.g., prevents the user from inputting text into numeric fields). But the cell phone may communicate with a host 532 to determine the order of the screens to display. The remote host 532 may communicate with a gaming facilitator 533 either through an intermediary communications exchange server (not shown) or with the gaming facilitator directly.

### Terminal Connectivity

The automated lottery system may work with a variety of terminal and device types. The connectivity to each variety is similar. In some embodiments of the automated lottery system, some terminals or devices from a gaming partner may use one connectivity methodology while others from the same gaming partner utilize a different methodology. For example, some gaming partners have ATMs that connect via dial-up and other ATMs that have networked connectivity. In this case, the dial-up connections may be directed to a modem pool provider which will accept the calls from the ATMs and translate those connections into networked based connections. The connections from the network based ATMs may communicate with the gaming facilitator for automated lottery system games but may connect to a payment processor for ATM transactions.

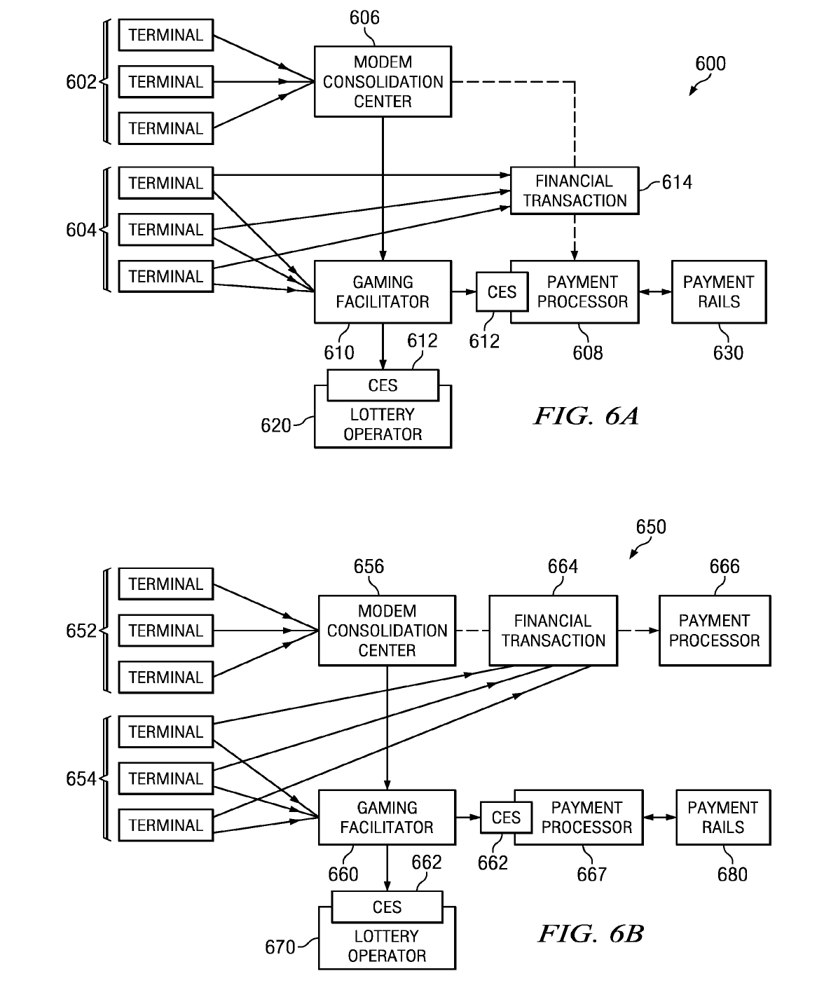

FIGS. 6A and 6B are schematic diagrams illustrating systems 600, 650 including gaming partners having multiple types of connectivity terminals 602, 604, 652, 654.

For example, system 600 includes terminals 602, which are dial-up ATM terminals connected to a modem consolidation center 606 via a dial-up connection. The modem consolidation center 606 is also connected to a gaming facilitator 610 via a secure network connection. In an embodiment, the modem consolidation center 606 communicates with the gaming facilitator 610 through a communications exchange server (not shown). System 600 may also include terminals 604 connected with the gaming facilitator 610 via a secure network connection. In an embodiment, the terminals 604 communicate with the gaming facilitator 610 through a communications exchange server (not shown).

The gaming facilitator 610 may communicate with a lottery operator 620 and a payment processor 608 associated with the terminal to facilitate lottery transactions initiated by users at the terminals 602, 604. Communications between the gaming facilitator 610 and lottery operator 620 may be through a communications exchange server 612. Communications between the gaming facilitator 610 and payment processor may also be through a communications exchange server 612.

If a user initiates a financial transaction 614, then the modem consolidation center 606 may route the financial transaction 614 through a payment processor 608 to the payment rails 630.

System 650 includes terminals 652, which are dial-up ATM terminals connected to a modem consolidation center 656 via a dial-up connection. The modem consolidation center 656 is also connected to a gaming facilitator 660 via a secure network connection. In an embodiment, the modem consolidation center 656 communicates with the gaming facilitator 660 through a communications exchange server (not shown). System 650 may also include terminals 654 connected with the gaming facilitator 660 via a secure network connection. In an embodiment, the terminals 654 communicate with the gaming facilitator 660 through a communications exchange server (not shown).

The gaming facilitator 660 may communicate with a lottery operator 670 and a payment processor 667 associated with the gaming facilitator to facilitate lottery transactions initiated by users at the terminals 652, 654. Communications between the gaming facilitator 660 and lottery operator 670 may be through a communications exchange server 662. Communications between the gaming facilitator 660 and payment processor may also be through a communications exchange server 662.

If a user initiates a financial transaction 664, then the modem consolidation center 656 may route the financial transaction 664 through a payment processor 666 associated with the terminal.

Some gaming partners may have proprietary connections to terminals, and, thus, their terminals may be connected to communication centers which then connect with a gaming facilitator either directly or through a communication exchange server. This would also include terminals with multiple functions that have one communication path, e.g., the case of ATMs that are in contact with a host (host-based terminals). These ATMs may send a message to the host indicating whether the user wishes to do an ATM transaction or an automated lottery system transaction. The host may then determine where to send the request (e.g., to the payment rails or to a gaming facilitator).

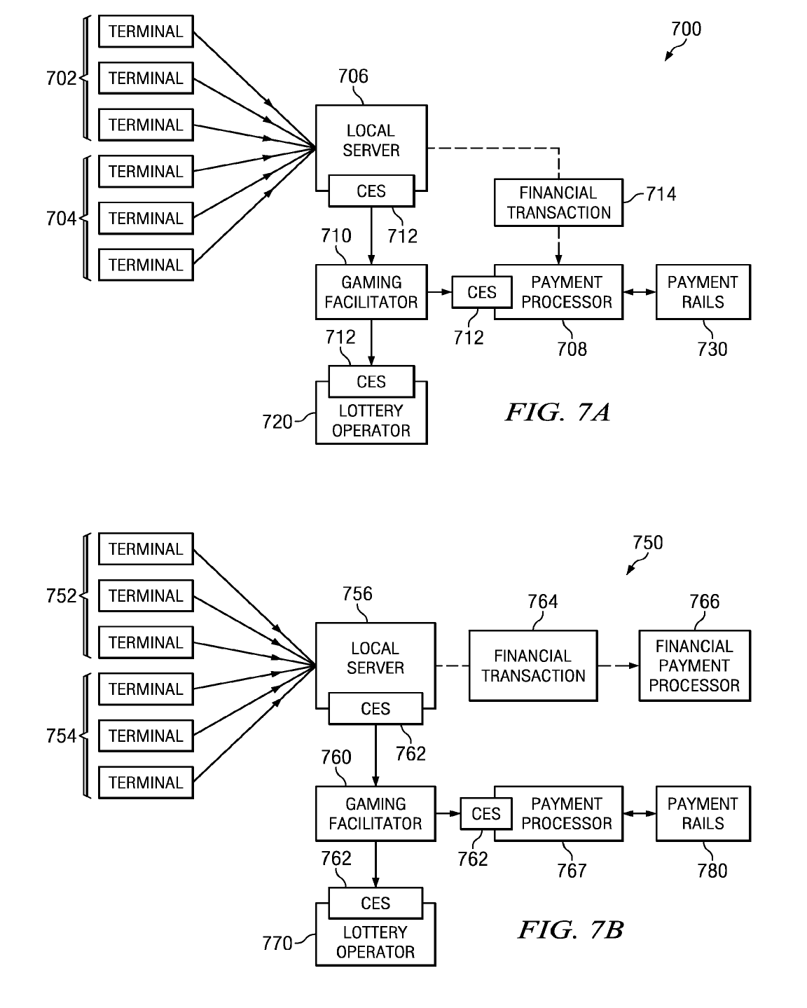

FIGS. 7A and 7B are schematic diagrams illustrating systems 700, 750 with gaming partners using a substantially direct communication to their terminals 702, 704, 752, 754.

For example, system 700 includes terminals 702, which are dial-up ATM terminals connected to a networked server 706 via a dial-up connection and terminals 704 connected to the networked server 706 via a secure network connection. The networked server 706 is also in communication with a gaming facilitator 710 via a secure network connection. In an embodiment, the networked server 706 communicates with the gaming facilitator 710 through a communications exchange server 712.

The gaming facilitator 710 may communicate with a lottery operator 720 and payment processor 708 to facilitate lottery transactions initiated by users at the terminals 702, 704. Communications between the gaming facilitator 710 and lottery operator 720 may be through a communications exchange server 712. Communications between the gaming facilitator 710 and payment processor 708 may also be through a communications exchange server 712.

If a user initiates a financial transaction 714, then the networked server 706 may route the financial transaction 714 through a payment processor 708 to the payment rails 730.

System 750 includes terminals 752, which are dial-up ATM terminals connected to a local server 756 via a dial-up connection and terminals 754 connected to the local server 756 via a secure network connection. The local server 756 is also in communication with a gaming facilitator 760 via a secure network connection. In an embodiment, the local server 756 communicates with the gaming facilitator 760 through a communications exchange server 762.

The gaming facilitator 760 may communicate with a lottery operator 770 and a payment processor 767 associated with the gaming facilitator to facilitate lottery transactions initiated by users at the terminals 752, 754. Communications between the gaming facilitator 760 and lottery operator 770 may be through a communications exchange server 762. Communications between the gaming facilitator 760 and payment processor 767 may also be through a communications exchange server 762.

If a user initiates a financial transaction 764, then the local server 756 may route the financial transaction 764 through a payment processor 766 associated with the terminal.

Some gaming partners may have proprietary connections to terminals, and, thus, their terminals may be connected to communication centers which then connect with a gaming facilitator either directly or through a communication exchange server. This would also include terminals with multiple functions that have one communication path, e.g., the case of ATMs that are in contact with a local server or host (host-based terminals). These ATMs may send a message to the host indicating whether the user wishes to do an ATM transaction or an automated lottery system transaction. The host may then determine where to send the request (e.g., to the payment rails or to a gaming facilitator).

In some embodiments, gaming partners have unique communication connections such as wireless terminals. Such is the case for taxis and portable devices such as cell phones and PDAs. In other embodiments, gaming partners have multiple devices aggregated at their location so multiple terminals are served by a single connection to the gaming facilitator. This is the case for POS terminals at multiple lanes in a supermarket or fuel pumps at a gas station.

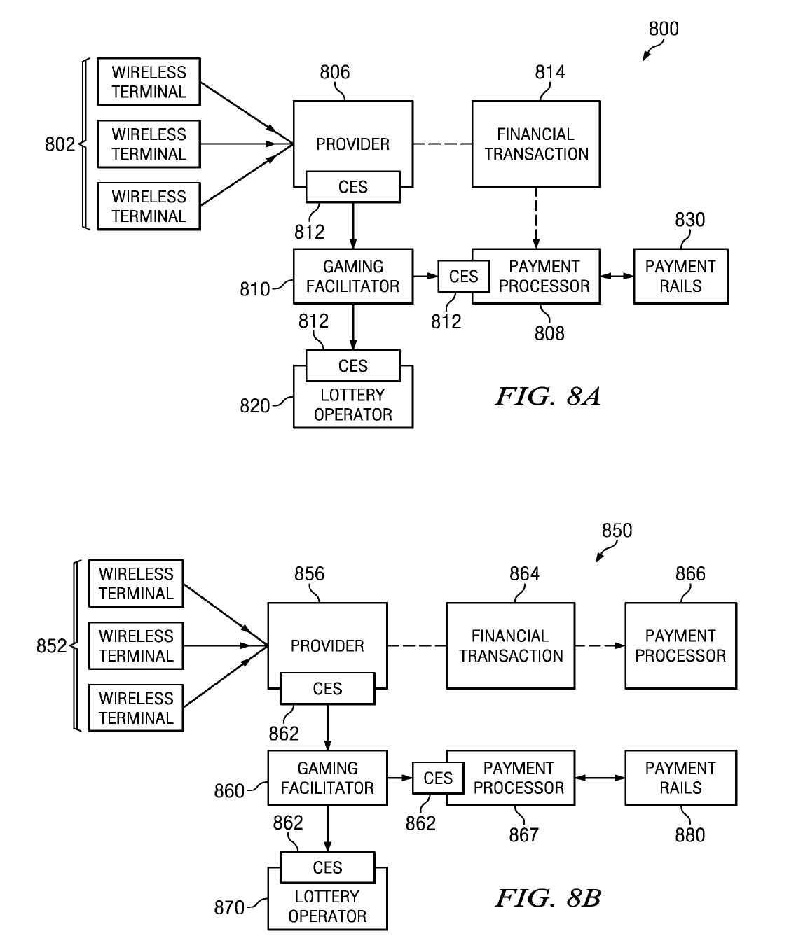

FIGS. 8A and 8B are schematic diagrams illustrating systems 800, 850 with gaming partners using a wireless communication to terminals 802, 852.

For example, system 800 includes terminals 802, which are connected to a provider 806 via a wireless connection. The provider 806 may be a wireless service provider, a taxi communication and data center, or any other kind of provider connected to a terminal via a wireless connection. The provider 806 is also in communication with a gaming facilitator 810 via a secure network connection. In an embodiment, the provider 806 communicates with the gaming facilitator 810 through a communications exchange server 812.

The gaming facilitator 810 may communicate with a lottery operator 820 and payment processor 808 to facilitate lottery transactions initiated by users at the terminals 802. Communications between the gaming facilitator 810 and lottery operator 820 may be through a communications exchange server 812. Communications between the gaming facilitator 810 and payment processor 808 may also be through a communications exchange server 812.

If a user initiates a financial transaction 814, then the provider 806 may route the financial transaction 814 through a payment processor 808 to the payment rails 830.

System 850 includes terminals 852, which are connected to a provider 856 via a wireless connection. The provider 856 may be a wireless service provider, a taxi communication and data center, or any other kind of provider connected to a terminal via a wireless connection. The provider 856 is also in communication with a gaming facilitator 860 via a secure network connection. In an embodiment, the provider 856 communicates with the gaming facilitator 860 through a communications exchange server 862.

The gaming facilitator 860 may communicate with a lottery operator 870 and a payment processor 867 that is associated with the gaming facilitator to facilitate lottery transactions initiated by users at the terminals 852. Communications between the gaming facilitator 860 and lottery operator 870 may be through a communications exchange server 862. Communications between the gaming facilitator 860 and payment processor 867 may also be through a communications exchange server 862.

If a user initiates a financial transaction 864, then the provider 856 may route the financial transaction 864 through a payment processor 866 that is associated with the provider.

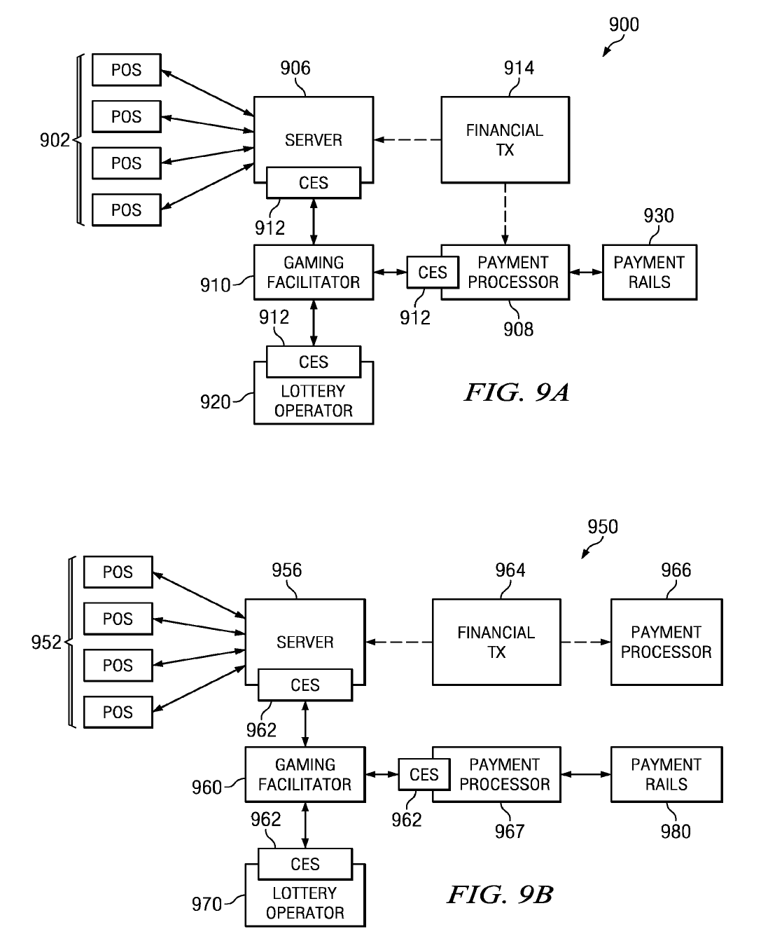

FIGS. 9A and 9B are schematic diagrams illustrating systems 900, 950 with gaming partners using a local network connection to terminals 902, 952.

For example, system 900 includes terminals 902, which are networked with a server 906 via a local network. The server 906 may be a back end server or set of networked servers in the local area network. The server 906 is also in communication with a gaming facilitator 910 via a secure network connection. In an embodiment, the server 906 communicates with the gaming facilitator 910 through a communications exchange server 912.

The gaming facilitator 910 may communicate with a lottery operator 920 and payment processor 908 to facilitate lottery transactions initiated by users at the terminals 902. Communications between the gaming facilitator 910 and lottery operator 920 may be through a communications exchange server 912. Communications between the gaming facilitator 910 and payment processor 908 may also be through a communications exchange server 912.

If a user initiates a financial transaction 914, then the server 906 may route the financial transaction 914 through a payment processor 908 to the payment rails 930.

System 950 includes terminals 952, which are connected to a server 956 via a local network. The server 956 may be a back end server or set of networked servers in the local area network. The server 956 is also in communication with a gaming facilitator 960 via a secure network connection. In an embodiment, the server 956 communicates with the gaming facilitator 960 through a communications exchange server 962.

The gaming facilitator 960 may communicate with a lottery operator 970 and a payment processor 967 that is associated with the gaming facilitator to facilitate lottery transactions initiated by users at the terminals 952. Communications between the gaming facilitator 960 and lottery operator 970 may be through a communications exchange server 962. Communications between the gaming facilitator 960 and payment processor 967 may also be through a communications exchange server 962.

If a user initiates a financial transaction 964, then the server 956 may route the financial transaction 964 through a payment processor 966 that is associated with the provider.

### Play Flow

As discussed above, different embodiments of terminals have different capabilities. Some terminals have the ability to store programs and logic while others may present what a host tells them to with the logic residing on the host. Still others may use a combination of these two approaches.

Terminal-based logic pertains to terminals having logic and programs stored on the terminal. In an embodiment, this is particularly advantageous for dial-up connections. In terminal-based logic systems, a user may go make certain decisions before a connection is established. Once a user makes certain decisions, the terminal may establish a connection with a gaming facilitator and receive a response in a relatively short time frame.

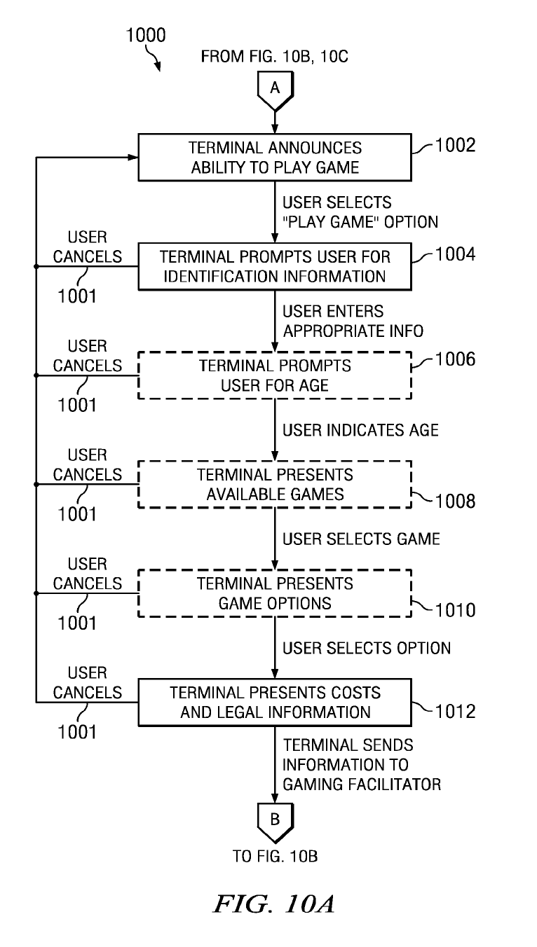

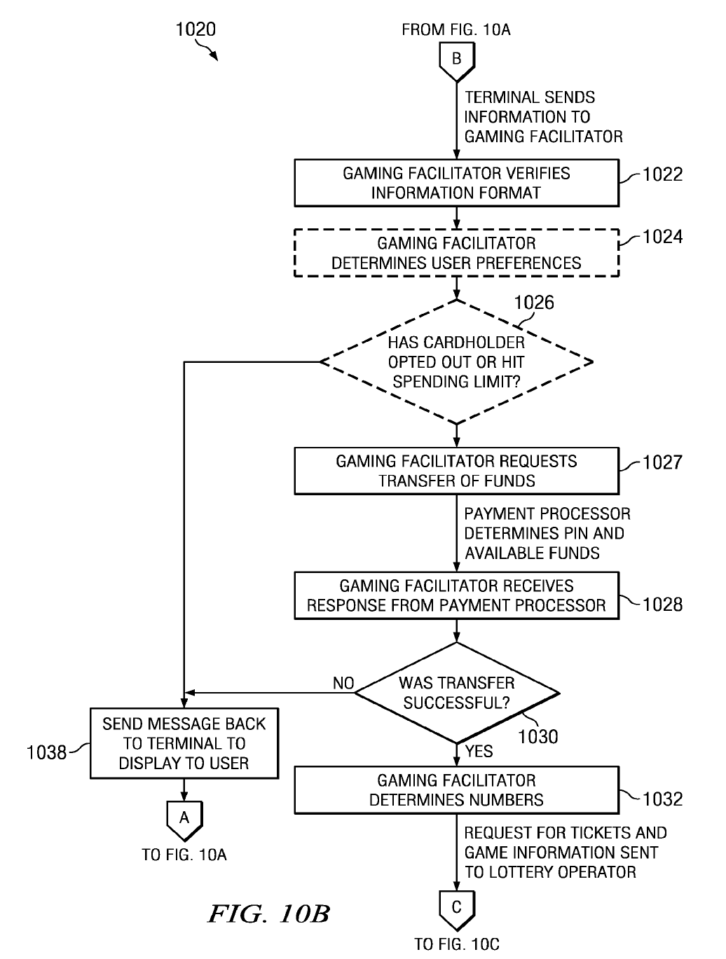

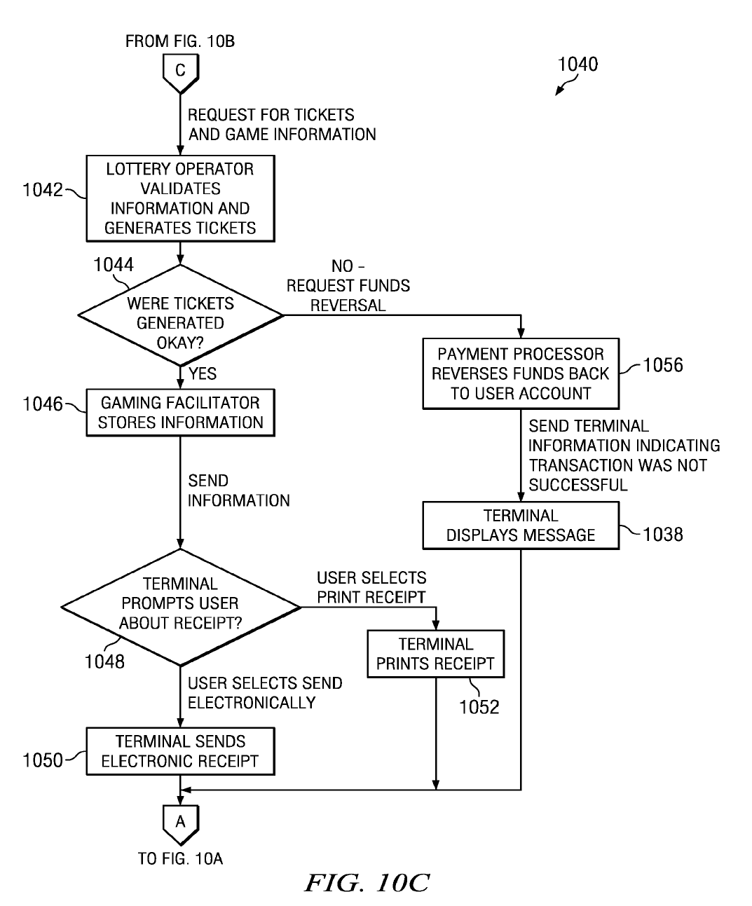

FIGS. 10A, 10B, and 10C are flow diagrams 1000, 1020, 1040 illustrating a process for a terminal-based play of an automated lottery system presented game. At action 1002, a terminal announces the ability for a user to play a game. In some embodiments, the terminal may present a screen indicating that the terminal is capable of providing game plays to the user. If a user decides to play a game, the terminal requests that the user input identification information at action 1004. For example, the terminal may ask the user for their preferred language at action 1004. For example, the terminal may request that the user swipe a debit card and enter their debit card pin at action 1004.

The terminal may optionally request that the user verify their age at action 1006 if the user's age has not been verified by previous input at the terminal. The terminal may also optionally present a list of game options available at the terminal location at action 1008. The list may include games that will become available at a future time and an indication that those games will be available in the future.

At action 1010, the terminal may present options for the selected game. For example, the terminal may present the number of tickets available for purchase, game play times available, etc. at action 1010. The terminal may also ask the user whether they would like to have their numbers sent to them or a link to their numbers sent to them. The terminal presents the cost associated with the user's selections as well as any necessary legal disclosures at action 1012. At any point in the process, the user may cancel the terminal transaction at action 1001. The terminal sends gaming information collected from the user to a gaming facilitator at action B.

The gaming facilitator may verify information format of the information sent by the terminal at action 1022. For example, at action 1022, the gaming facilitator may determine whether the information is sufficient and complete for a certain game play. The gaming facilitator may also ensure that the information is not corrupt. The gaming facilitator may also verify a user's age if their driver's license was presented at the terminal. If a driver's license is required by the game, but was not presented at the terminal, the gaming facilitator may cancel the transaction. If the transaction is canceled, the terminal may display a cancel message indicating the reason for the cancellation. At optional action 1024, the gaming facilitator may look up the user to determine preferences for that user.

At optional action 1026, the gaming facilitator may determine whether the user has opted out of the automated gaming system, whether the user has already hit their spending limit for a certain time period, etc. If either determination is affirmatively made at optional action 1026, then the gaming facilitator sends a message back to the terminal to display to the user at action 1038 and the process may begin again with the same or a new user at action A. If the determination is not affirmatively made at optional action 1026, then the process continues.

At action 1027, the gaming facilitator may request a transfer of funds for the transaction. For example, the gaming facilitator may request that a payment processor verify the user PIN number, whether enough funds are available in the user account for the transaction, and to transfer the funds. The payment processor determines whether the pin is correct and whether funds are available and sends a response to the gaming facilitator. The gaming facilitator receives the response from the payment processor act action 1028. The response may include, for example, verification from the payment processor whether the PIN is correct, whether funds are available, and/or whether the funds were transferred. If the gaming facilitator receives verification that the PIN is correct, that sufficient funds are available, and that the funds have been transferred at action 1030, the gaming facilitator generates random numbers or uses user-specified numbers for the game play at action 1032. If the gaming facilitator receives notification that the PIN is incorrect, that sufficient funds are not available, or that the funds were not transferred at action 1030, the gaming facilitator sends a message back to the terminal to display to the user at action 1038 and the process may begin again with the same or a new user at action A. A request for the desired number of tickets and games along with game information is sent by the gaming facilitator to the lottery operator at action C.

The lottery operator validates information received from the gaming facilitator and generates tickets if the information is validated at action 1042. The gaming facilitator determines whether the tickets were generated correctly at action 1044. If the tickets were not generated correctly, the gaming facilitator requests a funds reversal to the payment processor, and the payment processor may reverse the funds back to the user account at action 1056. The gaming facilitator sends a message back to the terminal to display to the user at action 1038 and the process may begin again with the same or a new user at action A. If the tickets were generated correctly, the gaming facilitator will store game play information at action 1046. The gaming facilitator sends to the terminal game play numbers, transaction numbers, and a confirmation of the transaction. The terminal may prompt the user to indicate whether to print a receipt at the terminal or receive a receipt electronically at action 1048. If the user selects to print the receipt, the terminal prints the receipt at action 1052 and the process may begin again with the same or a new user at action A. If the user selects to receive the receipt electronically, the terminal gathers user information and sends the electronic receipt at action 1050. The process may begin again with the same or a new user at action A.

Host-based terminals are terminals that receive instructions from a host instead of having internal local logic. Accordingly, a process for a host-based play of an automated lottery system presented game is slightly different than the terminal-based play. A host-based terminal is connected to a host from the beginning of a transaction, whereas a terminal-based terminal might connect to the host or to a gaming facilitator after certain decisions and actions are taken by a user during a transaction. Being connected earlier allows the host-based terminal to query a gaming facilitator database for information about the user at an earlier time in the transaction. This is also the case for terminal-based play flow where the terminal has a substantially constant connection such as with a network connection.

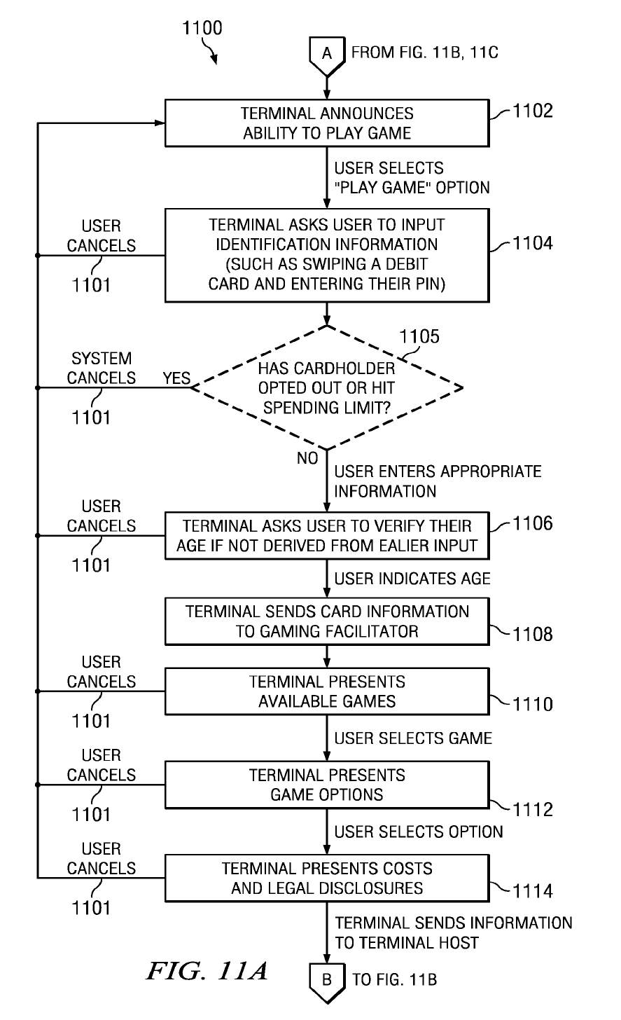

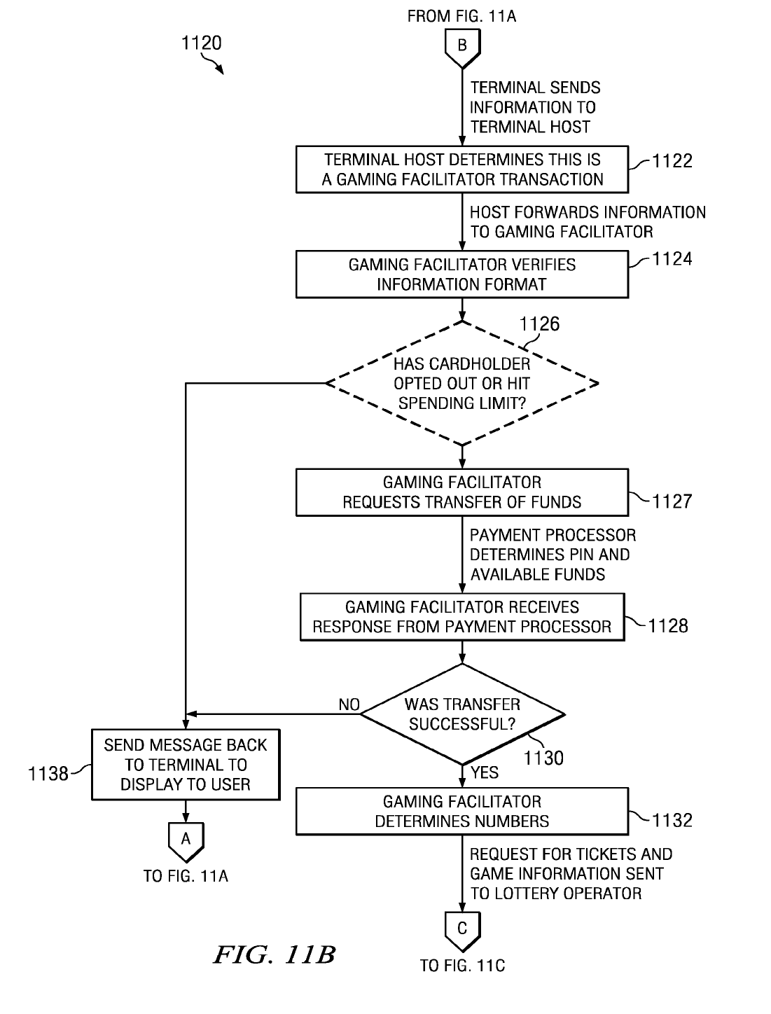

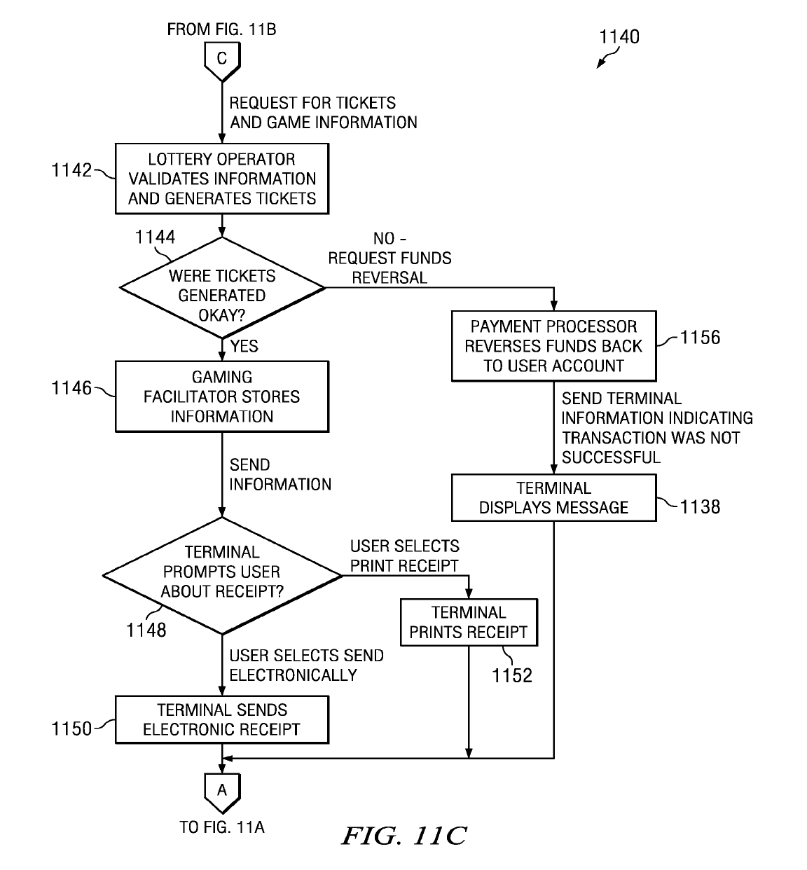

FIGS. 11A, 11B, and 11C are flow diagrams 1100, 1120, 1140 illustrating a process for a host-based play (and terminal-based play where the terminal has a substantially constant connection) of an automated lottery system presented game. At action 1102, a terminal announces the ability for a user to play a game. For example, the terminal may present a screen indicating that the terminal is capable of providing game plays to the user. If a user decides to play a game, the terminal requests that the user input identification information at action 1104. In some embodiments, the terminal may ask the user for their preferred language at action 1104. In some embodiments, the terminal may request that the user swipe a debit card and enter their debit card pin at action 1104.

In an embodiment, at optional action 1105, the gaming facilitator may determine whether the user has opted out of the automated gaming system, whether the user has already hit their spending limit for a certain time period, etc. If either determination is affirmatively made at optional action 1105, then the gaming facilitator system cancels the transaction at action 1101. The system may send a message back to the terminal to display to the user and the process may begin again with the same or a new user at action A. If the determination is not affirmatively made at optional action 1105, then the process continues at action 1106.

The terminal also requests that the user verify their age at action 1106 if the user's age has not been verified by previous input at the terminal. The terminal sends card information to a gaming facilitator (via a host terminal) at action 1108 to determine whether the user is a registered user. The terminal may present a list of game options available at the terminal location at action 1111. The list may include games that will become available at a future time and an indication that those games will be available in the future. At action 1112, the terminal may present options for the selected game. For example, the terminal may present the number of tickets available for purchase, game play times available, etc. at action 1112. The terminal may also ask the user whether they would like to have their numbers sent to them or a link to their numbers sent to them. The terminal presents the cost associated with the user's selections as well as any necessary legal disclosures at action 1114. At any point in the process, the user may cancel the terminal transaction at action 1101. The terminal sends gaming information collected from the user to a terminal host at action B.

At action 1122, a terminal host determines based on the information sent from the terminal that the transaction is a gaming facilitator transaction. The host may forward the information to the gaming facilitator. The gaming facilitator may verify information format of the information sent by the terminal at action 1124. For example, at action 1124, the gaming facilitator may determine whether the information is sufficient and complete for a certain game play. The gaming facilitator may also ensure that the information is not corrupt. The gaming facilitator may also verify a user's age if their driver's license was presented at the terminal. If a driver's license is required by the game, but was not presented at the terminal, the gaming facilitator may cancel the transaction. If the transaction is canceled, the terminal may display a cancel message indicating the reason for the cancellation.

In an embodiment, at optional action 1126, the gaming facilitator may look up the user to determine preferences for that user. At action 1126, the gaming facilitator may determine whether the user has opted out of the automated gaming system, whether the user has already hit their spending limit for a certain time period, etc. If either determination is affirmatively made at action 1126, then the gaming facilitator sends a message back to the terminal (e.g., via the terminal) host to display to the user at action 1138 and the process may begin again with the same or a new user at action A. If the determination is not affirmatively made at action 1126, then the process continues.

At action 1127, the gaming facilitator may request a transfer of funds for the transaction. For example, the gaming facilitator may request that a payment processor verify the user PIN number, whether enough funds are available in the user account for the transaction, and to transfer the funds. The payment processor determines whether the pin is correct and whether funds are available and sends a response to the gaming facilitator. The gaming facilitator receives the response from the payment processor act action 1128. The response may include, for example, verification from the payment processor whether the PIN is correct, whether funds are available, and/or whether the funds were transferred.

The gaming facilitator receives verification from the payment processor whether the PIN is correct, whether funds are available, and/or whether the funds were transferred at action 1128. If the gaming facilitator receives verification that the PIN is correct, that sufficient funds are available, and that the funds have been transferred at action 1130, the gaming facilitator generates random numbers or uses user-specified numbers for the game play at action 1132. If the gaming facilitator receives notification that the PIN is incorrect, that sufficient funds are not available, or that the funds were not transferred at action 1130, the gaming facilitator sends a message back to the terminal (e.g., via the terminal host) to display to the user at action 1138 and the process may begin again with the same or a new user at action A. A request for the desired number of tickets and games along with game information is sent by the gaming facilitator to the lottery operator at action C.

The lottery operator validates information received from the gaming facilitator and generates tickets if the information is validated at action 1142. The gaming facilitator determines whether the tickets were generated correctly at action 1144. If the tickets were not generated correctly, the gaming facilitator requests a funds reversal to the payment processor, and the payment processor may reverse the funds back to the user account at action 1156. The gaming facilitator sends a message back to the terminal to display to the user at action 1138 and the process may begin again with the same or a new user at action A. If the tickets were generated correctly, the gaming facilitator will store game play information at action 1146. The gaming facilitator sends to the terminal (e.g., via the terminal host) game play numbers, transaction numbers, and a confirmation of the transaction. The terminal may prompt the user to indicate whether to print a receipt at the terminal or receive a receipt electronically at action 1148. If the user selects to print the receipt, the terminal prints the receipt at action 1152 and the process may begin again with the same or a new user at action A. If the user selects to receive the receipt electronically, the terminal gathers user information and sends the electronic receipt at action 1150. The process may begin again with the same or a new user at action A.

### Winner Determination

Winners are paid automatically if possible, though, in some instances, a State Lottery Commission (SLC) may limit the amount that a lottery retailer (i.e., an automated gaming system) can pay out. Amounts greater than this limit may be paid by a player going to a State Lottery Commission in person, which provides the State Lottery Commission an opportunity to gather information for tax-related purposes about the player.

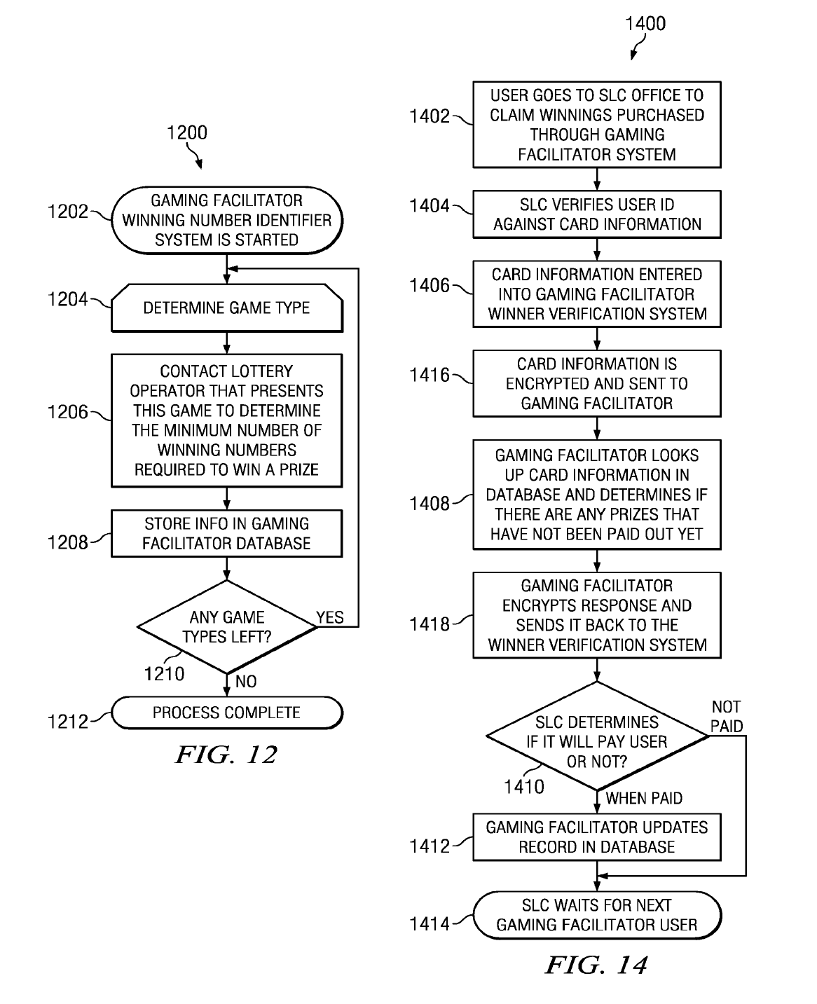

FIG. 12 is a flow diagram illustrating an automated process for determining winning tickets 1200. In an embodiment, a gaming facilitator winning number identifier system performs the process of FIG. 12. The winning number identifier system may part of a logic engine of the gaming facilitator system.

At action 1202, a winning number identifier system is started at the gaming facilitator. In an embodiment, the winning number identifier system is a winner determination server in the gaming facilitator. At action 1204, a game type is determined. The game type may be one of the games that a gaming facilitator user may play. For the determined game type, at action 1206, the winning number identifier system communicates with a lottery operator associated with the determined game type. The winning number identifier system may request and receive winning numbers, a minimum number of winning numbers required to win a prize, and/or other winning information from the associated lottery operator. To determine which tickets are winners, the winning number identifier system may communicate with a lottery operator after a game to obtain a list of winning numbers. However, many lottery games allow for winning tickets when fewer than every number matches the winning number. If a subset of the winning numbers is matched, the ticket may still be a winner but the prize may be less than the grand prize amount. So, in addition to having the winning numbers, depending on the game type, the winning number identifier system may also obtain the minimum number of numbers to match for a ticket to be deemed a winner. At action 1208, the winning numbers, minimum number of winning numbers required to win a prize, and/or other winning information is stored in a gaming facilitator database. At action 1210, the winning number identifier system determines whether any other game types are available for winner determination. If other game types are available, the process loops back to action 1204, where the next game type is determined. If no other game types are available, the process is complete at action 1212.

Once the list of winning numbers and the minimum number of matching numbers has been identified, a gaming facilitator winner detection system may go through the tickets purchased for that game to determine the status of the tickets.

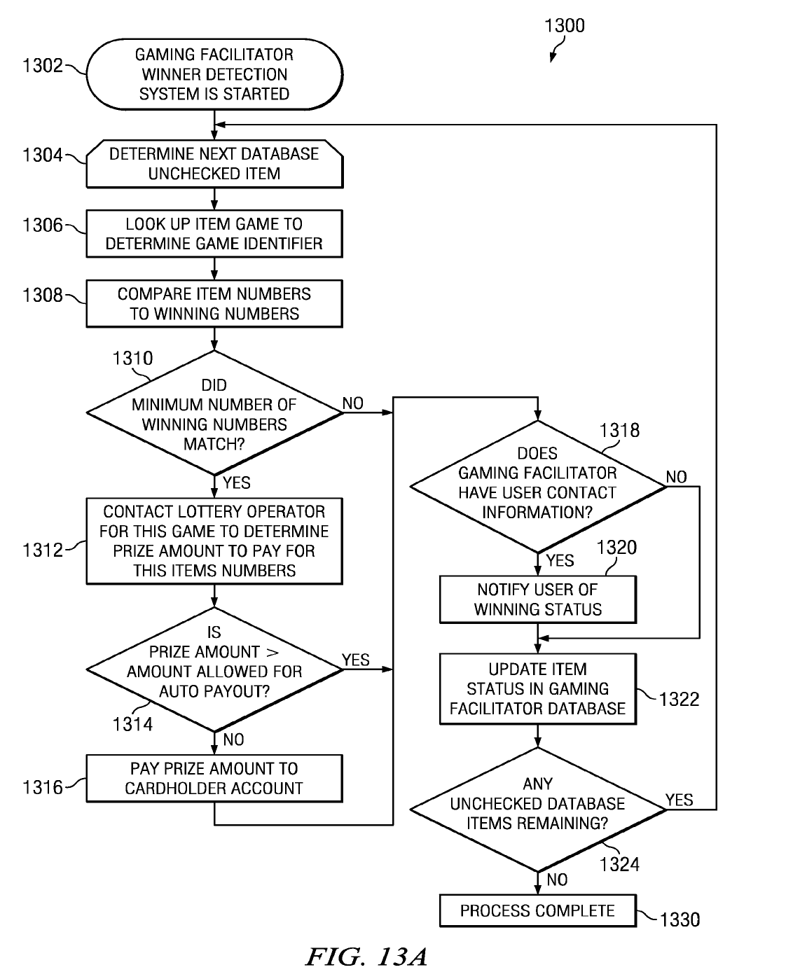

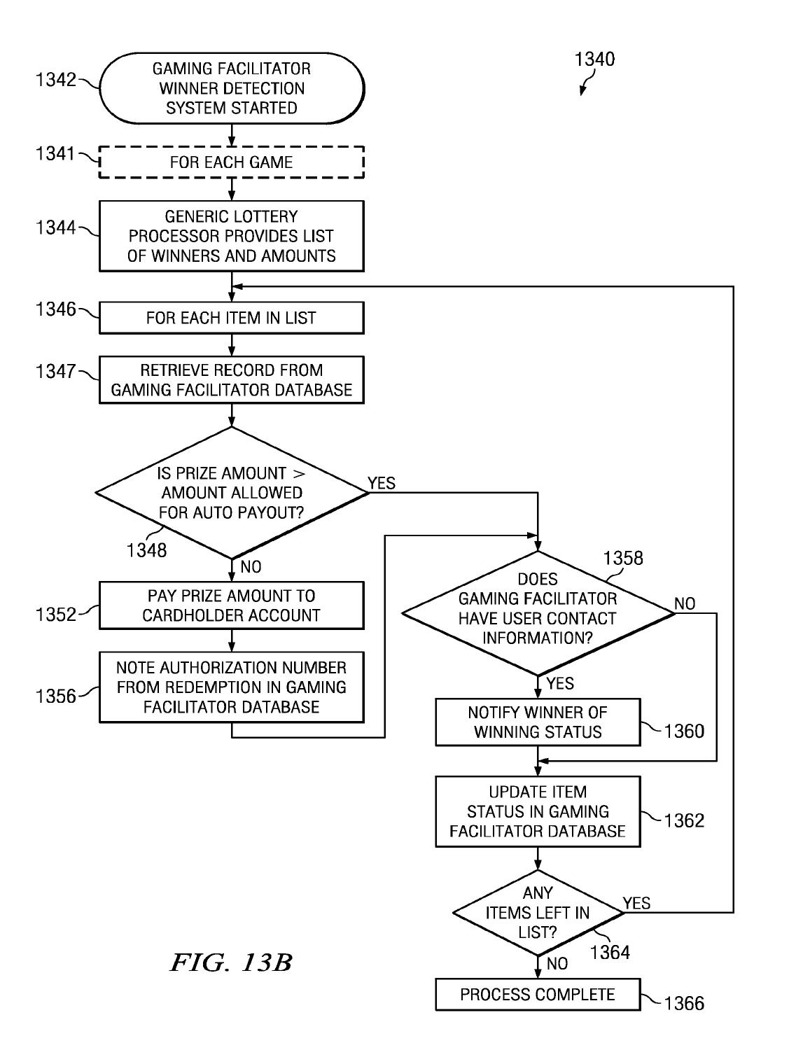

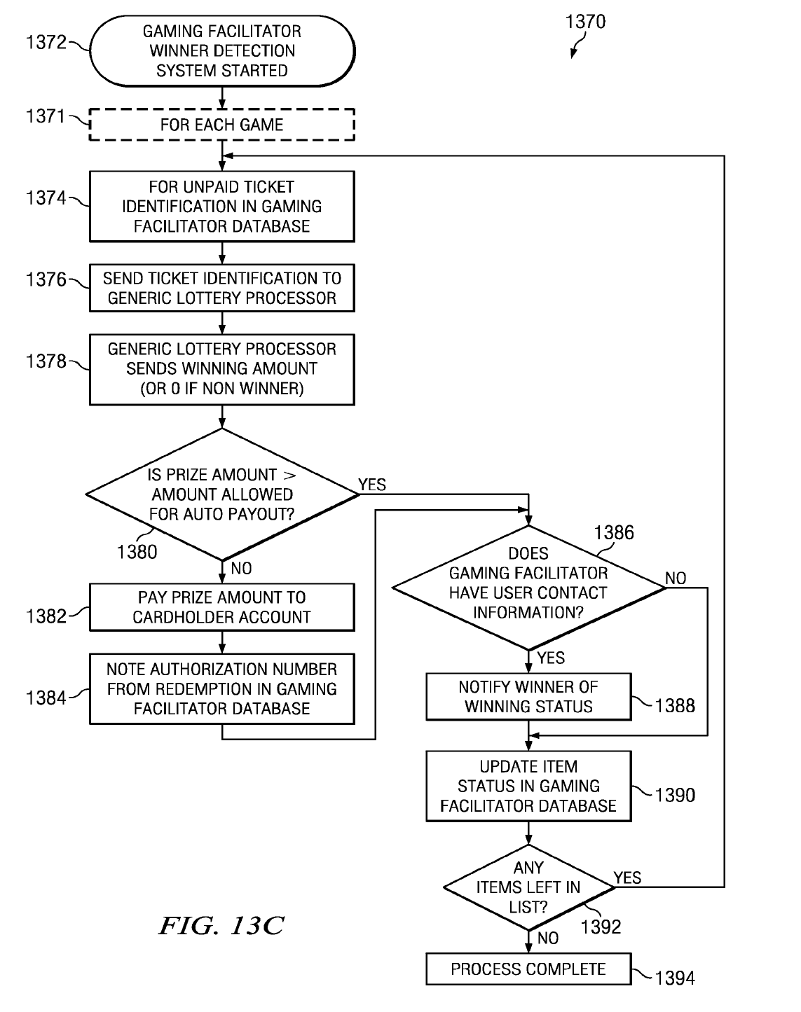

FIGS. 13A, 13B, and 13 are flow diagrams illustrating automated processes for detecting winning tickets 1300, 1340, 1370. In an embodiment, a gaming facilitator winner detection system performs one or more of the processes 1300, 1340, 1370. The winner detection system may part of a logic engine of the gaming facilitator system.

Referring now to process 1300, at action 1302, a winner detection system is started at the gaming facilitator. In an embodiment, the winner detection system is a winner detection server in the gaming facilitator. At action 1304, an unchecked gaming facilitator database item is determined. An item game identifier associated with the game play and the game play numbers associated with the game play for the item are determined at action 1306. The game play numbers associated with the game play for the item are compared to winning numbers in the gaming facilitator database at action 1308. At action 1310, the winner detection system determines whether a minimum number of winning numbers matched the game play numbers associated with the game play for this item.

If a sufficient number is not matched, at action 1318 the winner detection system determines whether the gaming facilitator has the user's contact information at action 1318. If so, then the gaming facilitator may communicate an un-winning status to the user at action 1320. If not, then the item status is updated in the gaming facilitator database at action 1322.

If a sufficient number matched, at action 1312 the ticket information is sent to the lottery operator for validation and to determine the prize amount to pay. At action 1314, the winner detection system determines whether the prize amount exceeds an amount allowed for automatic payment. If the amount is less than the SLC limit, the amount is paid to the cardholders account at action 1316.

If the prize amount exceeds an amount allowed for automatic payment at action 1314, the winner detection system determines whether the gaming facilitator has the user's contact information at action 1318. If so, then the gaming facilitator may communicate the winning status to the user at action 1320. If not, then the item status is updated in the gaming facilitator database at action 1322.

The winner detection system may determine whether any unchecked items remain in the gaming facilitator database at action 1324. If unchecked items remain, the process loops back to action 1304. If no unchecked items remain, then the process is complete at action 1330.

Referring now to process 1340, at action 1342, a winner detection system is started at the gaming facilitator. In an embodiment, the process 1340 is repeated for each game type (action 1341). In an embodiment, the winner detection system is located in a logic engine of the gaming facilitator.

At action 1344, the winner detection system receives a list of winners and amounts of the winnings from a generic lottery processor. The list includes information for tickets purchased through that generic lottery processor by the gaming facilitator. For each item in the list (action 1346), the winner detection system retrieves a record associated with that item from a gaming facilitator database at action 1347.

At action 1348, the winner detection system determines whether the prize amount exceeds an amount allowed for automatic payment. If the amount is less than the SLC limit, the amount is paid to the cardholders account at action 1352. The winner detection system records a redemption authorization number in the gaming facilitator database at action 1356.

If the prize amount exceeds an amount allowed for automatic payment at action 1348, the winner detection system determines whether the gaming facilitator has the user's contact information at action 1358. If so, then the gaming facilitator may communicate the winning status to the user at action 1360. If not, then the item status is updated in the gaming facilitator database at action 1362.

The winner detection system may determine whether any unchecked items remain in the gaming facilitator database at action 1364. If unchecked items remain, the process loops back to action 1346. If no unchecked items remain, then the process is complete at action 1366.

Referring now to process 1370, at action 1372, a winner detection system is started at the gaming facilitator. In an embodiment, the process 1370 is repeated for each game type (action 1371). In an embodiment, the winner detection system is located in a logic engine of the gaming facilitator.

At action 1374, the winner detection system identifies any unpaid ticket IDs remaining in a gaming facilitator database. The ticket ID is sent to a generic lottery processor at action 1376. The winner detection system receives a winning amount (which may be zero, if the ticket is a non-winner) from the generic lottery processor at action 1378.

At action 1380, the winner detection system determines whether the prize amount exceeds an amount allowed for automatic payment. If the amount is less than the SLC limit, the amount is paid to the cardholders account at action 1382. The winner detection system records a redemption authorization number in the gaming facilitator database at action 1384.

If the prize amount exceeds an amount allowed for automatic payment at action 1380, the winner detection system determines whether the gaming facilitator has the user's contact information at action 1386. If so, then the gaming facilitator may communicate the winning status to the user at action 1388. If not, then the item status is updated in the gaming facilitator database at action 1390.

The winner detection system may determine whether any unpaid ticket IDs remain in the gaming facilitator database at action 1392. If unchecked items remain, the process loops back to action 1374. If no unchecked items remain, then the process is complete at action 1394.

In the case that a player may go to a State Lottery Commission to redeem their winnings—i.e., the winner deserves a prize greater than a certain amount or were informed that an automatic payout failed—a method to verify the winner is provided. In an embodiment, the State Lottery Commission may be provided with a gaming facilitator winner verification terminal.

FIG. 14 is a flow diagram illustrating a process for winner verification 1400 involving a State Lottery Commission. In an embodiment, a gaming facilitator winner verification terminal performs at least part of the process of FIG. 14. At action 1402, a gaming facilitator user goes to a State Lottery Commission office to claim winnings purchased through a gaming facilitator system. At action 1404, the State Lottery Commission may verify the identity of the person, e.g., using a photo ID, and may verify that they are the cardholder. If the user is a registered gaming facilitator user, then a gaming facilitator PIN or a card PIN number may be entered into the gaming facilitator winner verification system for verification at action 1406. Once the identity has been verified, the State Lottery Commission may encrypt and send the card information to the gaming facilitator through the gaming facilitator winner verification terminal at action 1416. The gaming facilitator will determine whether any outstanding prizes for that cardholder are available at action 1408. The gaming facilitator may encrypt and return the information to the State Lottery Commission at action 1418. The State Lottery Commission will determine whether to pay the user at action 1410 based on their existing payout procedures. If the State Lottery Commission pays out any winnings, the State Lottery Commission notifies the gaming facilitator via the gaming facilitator winner verification terminal so that the gaming facilitator may update the user record in a database at action 1412. This prevents the same prize from being paid multiple times. The State Lottery Commission waits for the next gaming facilitator user at action 1414.

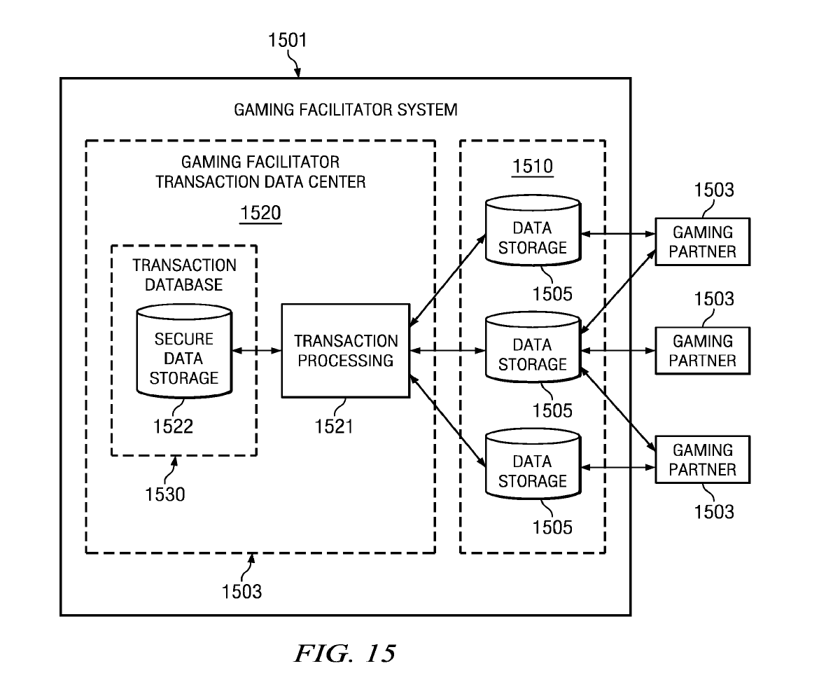

FIG. 15 is a schematic diagram illustrating a gaming facilitator system 1501. At a high level, the gaming facilitator system 1501 may include a gaming facilitator transaction data center 1520 and partner accessible data storage 1505. The gaming facilitator transaction data center 1520 may include a transaction database 1530 with secure data storage 1522. The data center 1520 may also include transaction processing server 1521, which may include a logic engine (not shown). The transaction processing server 1521 and transaction database 1530 are shown as a single server and database, respectively, for simplicity purposes only but may actually comprise a set of networked servers or databases.

The transaction processing server 1521 is in communication with partner accessible data storage 1505 and with the secure data storage 1522. In an embodiment, gaming facilitator system partners operate the partner accessible data storage 1505.

In an embodiment, gaming partners 1503 may access information from the partner accessible data storage 1505, but may not directly access the secure data storage 1522 of the data center 1520. Accordingly, in some embodiments, the gaming facilitator may store certain gaming partner information in the partner accessible data storage 1505. The information that the gaming facilitator does not wish the gaming partner to access may be stored at secure data storage 1522 in the data center 1520.

In an embodiment, the partner accessible data storage 1505 also incorporates security mechanisms, as the information stored in storage 1505 may not all be public information.

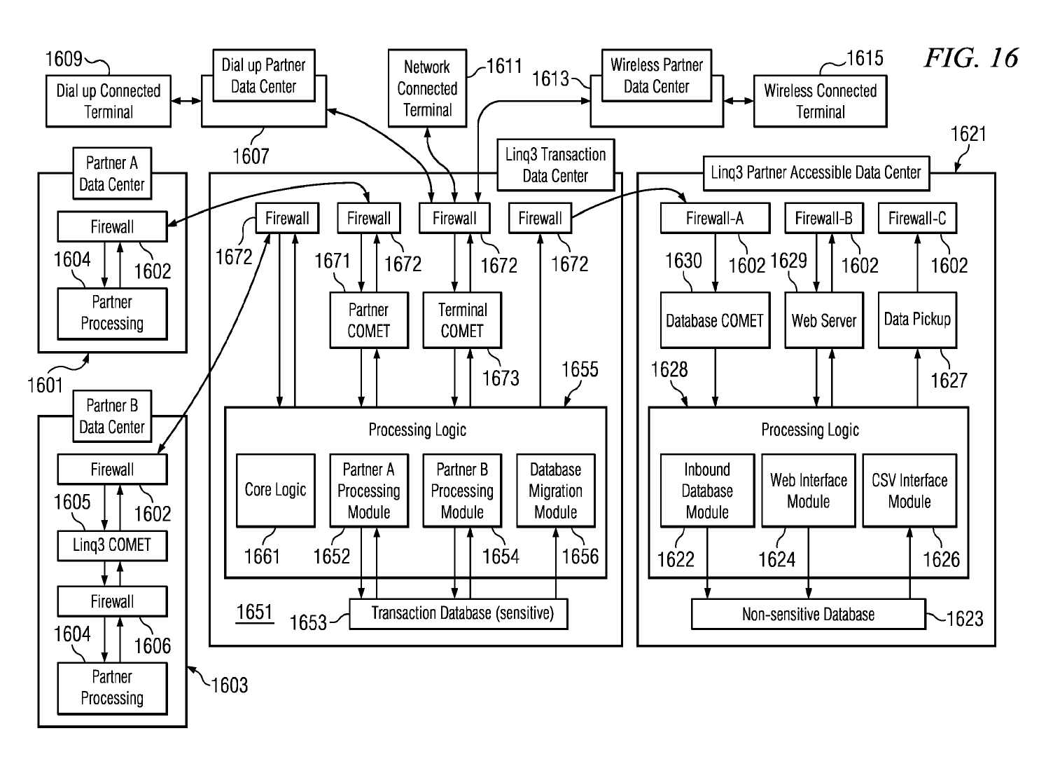

FIG. 16 is a schematic diagram illustrating a gaming facilitator system 1600. System 1600 may include a gaming facilitator transaction data center 1651, dial-up connected terminal 1609, dial-up partner data center 1607, network connected terminal 1611, wireless partner data center 1613, wireless connected terminal 1615, gaming facilitator partner accessible data center 1621, a partner data center 1601 and another partner data center 1603.

The gaming facilitator transaction data center 1651 is in communication with the dial-up partner data center 1607, network connected terminal 1611, wireless partner data center 1613, gaming facilitator partner accessible data center 1621, and partner data centers 1601, 1603. In some embodiments, the communication with the gaming facilitator transaction data center 1651 may be made via communications exchange servers 1605, 1630, 1671, 1673. Firewalls 1602, 1606, 1665 provide isolation between various systems and components in the system 1600.

Partner data centers 1601, 1603 may include partner processing servers 1604. The partner data center 1601 does not include a communications exchange server. Accordingly, the partner data center 1601 may communicate with the gaming facilitator data center 1651 via the communications exchange server 1671 at the gaming facilitator data center 1651. The partner data center 1601 connects to the communications exchange server 1671 via a secure connection to firewall 1672. The partner data center 1603 includes a communications exchange server 1605. Thus the partner data center 1603 may connect with the gaming facilitator data center 1651 via the communications exchange server 1605. The partner data center 1603 connects with the gaming facilitator data center 1651 via a secure connection (e.g., MPLS or other “private” connection) between the firewall 1602 at the partner data center 1603 and firewall 1672 at the gaming facilitator data center 1651.

The dial-up connected terminal 1609 is in communication with the dial-up partner data center 1607. The dial-up partner data center communicates with a terminal communications exchange server 1673 at the gaming facilitator data center 1651 via secure connection to the gaming facilitator data center firewall 1672.

The network connected terminal 1611 communicates with the terminal communications exchange server 1673 at the gaming facilitator data center 1651 via secure connection to the gaming facilitator data center firewall 1672.

The wireless connected terminal 1615 is in communication with the wireless partner data center 1613. The wireless partner data center 1613 communicates with a terminal communications exchange server 1673 at the gaming facilitator data center 1651 via secure connection to the gaming facilitator data center firewall 1672.

The gaming facilitator partner accessible data center 1621 is in communication with the gaming facilitator data center 1651 via a secure connection between the firewall 1602 at the gaming facilitator partner accessible data center 1621 and the gaming facilitator firewall 1672.

Gaming facilitator transaction data center 1651 may further include processing logic 1655, which may include core logic 1661, partner processing logic modules 1652, 1654, and database migration logic module 1656. The processing logic 1655 may be in communication with a transaction database 1653. The transaction database 1653 is highly secure, and, in an embodiment, gaming facilitator partners do not have direct access to the transaction database 1653.

The gaming facilitator partner accessible data center 1621 may further include a processing logic 1628, web server 1629, data pickup 1627, and a database 1623. The processing logic 1628 may include logic modules 1622, 1624, 1626. In an embodiment, other gaming partners (not shown) may access information from the partner accessible data center 1621, but may not directly access the secure data storage 1653 of the gaming facilitator data center 1651. Accordingly, in some embodiments, the gaming facilitator may store certain gaming partner information in the partner accessible data center 1621. The information that the gaming facilitator does not wish some gaming partners to access may be stored in database 1653 in the data center 1651.

While various embodiments in accordance with the disclosed principles have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings herein.

What is claimed is:

1. An automated lottery system for facilitating a lottery purchase transaction at a device associated with a user, the system comprising:
a gaming facilitator system adapted for communication with a gaming partner and at least one device associated with a user, the gaming facilitator comprising:
a transaction database operable to store a plurality of lottery purchase information records associated with a plurality of respective payment card number records; and
a transaction processing server in communication with the transaction database, the transaction processing server operable to receive a payment card number of the user and game play acceptance information, to generate lottery purchase information based on the game play acceptance information, and to associate the lottery purchase information with the payment card number for a given lottery purchase transaction.

2. The system of claim 1, wherein the transaction processing server is further operable to communicate the payment card number and lottery purchase information to the transaction database for storage.

3. The system of claim 1, wherein the transaction processing server is further in communication with the gaming partner and receives the game play acceptance information from the gaming partner.

4. The system of claim 1, wherein the transaction processing server is further in communication with the at least one device associated with the user and receives the payment card number from the at least one device.

5. The system of claim 1, wherein the gaming facilitator system is operable to effect a ticketless lottery transaction using a lottery purchase information record associated with a respective payment card number record in the transaction database.

6. The system of claim 1, wherein the gaming facilitator system is operable to effect automatic lottery redemption using a lottery purchase information record associated with a respective payment card number record in the transaction database.

7. The system of claim 6, wherein redemption is initiated based upon a payment card number record associated with a respective winning lottery purchase information record.

8. The system of claim 6, wherein redemption is initiated without the gaming facilitator system requiring knowledge of user bank information, a user name, or a user address.

9. The system of claim 1, wherein the gaming facilitator system is operable to provide for a right of lottery redemption without a bearer instrument using a lottery purchase information record associated with a respective payment card number record in the transaction database.

10. The system of claim 1, wherein the gaming facilitator system is further operable to receive lottery winner information from the gaming partner and to determine a winning payment card number associated with the lottery winner information.

11. The system of claim 10, wherein the gaming facilitator system is further operable to forward instructions to a processor to deposit winning funds into an account corresponding to the winning payment card number.

12. The system of claim 1, wherein the gaming partner comprises one or more gaming partner servers, and wherein the gaming facilitator system further comprises:
one or more gaming facilitator servers; and
the one or more gaming partner servers, the one or more gaming facilitator servers adapted to communicate with the one or more gaming partner servers.

13. The system of claim 1, wherein the gaming facilitator system further comprises:
one or more gaming partner servers, the one or more gaming partner servers operable to generate game play acceptance information.

14. The system of claim 1, wherein the gaming facilitator system is adapted for communication with the gaming partner over a secure communication network, and wherein the gaming facilitator system receives the game play acceptance information over the secure communication network.

15. The system of claim 1, wherein the payment card number is one of a debit card number and a credit card number.

16. The system of claim 1, wherein the gaming facilitator system further comprises:
a winner detection server operable to compare the winning game play numbers with the plurality of lottery purchase information records stored in the transaction database to determine one or more winning records.

17. The system of claim 16, wherein the winner detection server is further operable to determine whether a minimum number of winning numbers in the one or more winning records matches the winning game play numbers.

18. The system of claim 16, wherein the winner detection server is further operable to send ticket information to the gaming partner for validation, and to determine a prize amount associated with the ticket information.

19. The system of claim 18, wherein the winner detection server is further operable to determine whether the prize amount exceeds an amount allowed for automatic payment.

20. The system of claim 18, further comprising a winner redemption server operable to initiate redemption if the prize amount is less than an amount allowed for automatic payment.

21. The system of claim 20, wherein the winner redemption server is operable to initiate redemption based upon a payment card number record associated with a respective winning lottery purchase information record.

22. The system of claim 1, further comprising:
a winner detection server operable to receive a list of winners and corresponding winning amounts associated with the winners from a generic lottery processor, and further operable to retrieve, for each item in the list of winners, a record associated with that item from the transaction database.

23. The system of claim 22, wherein the winner detection server is further operable to determine whether a winning amount exceeds an amount allowed for automatic payment.

24. The system of claim 23, further comprising a winner redemption server operable to initiate payment of the winning amount to a user account, the user account associated with a winning user's payment card number, if the winning amount is less than the amount allowed for automatic payment.

25. The system of claim 24, wherein the winner redemption server is further operable to record a redemption authorization number in the transaction database.

26. The system of claim 1, further comprising:
a gaming facilitator winner detection system comprising a winner detection server operable to identify an unpaid ticket identifier in a transaction database and to transmit the unpaid ticket identifier to a generic lottery processor.

27. The system of claim 26, wherein the winner detection server is further operable to receive a winning amount from the generic lottery processor and to determine whether the winning amount exceeds an amount allowed for automatic payment.

28. The system of claim 27, further comprising a winner redemption server operable to initiate redemption if the winning amount is less than an amount allowed for automatic payment.

29. The system of claim 28, wherein the winner redemption server is further operable to initiate redemption based upon a payment card number associated with a respective winning lottery purchase information record.

30. A method for facilitating a lottery purchase transaction in a gaming facilitator system adapted for communication with a gaming partner and at least one device associated with a user:
receiving, at a transaction processing server in the gaming facilitator system, a payment card number associated with the user, and game play acceptance information;
generating, at the transaction processing server, the lottery purchase information based on the game play acceptance information;
associating, at the transaction processing server, the lottery purchase information with the payment card number; and
storing the payment card number and the lottery purchase information at the transaction database.

31. The method of claim 30, further comprising, storing, at a transaction database, a plurality of lottery purchase information records associated with a plurality of respective payment card number records for a plurality of lottery purchase transactions.

32. The method of claim 31, further comprising:
referencing the plurality of lottery purchase information records associated with a plurality of respective payment card number records;
determining whether a winning game play exists in the lottery purchase information records; and
if a winner is determined, initiating automatic redemption for a user associated with a payment card number associated with the winning game play.

33. The method of claim 30, wherein receiving further comprises receiving the game play acceptance information from the gaming partner.

34. The method of claim 30, wherein receiving further comprises receiving the payment card number from the at least one device.

35. The method of claim 30, wherein associating the lottery purchase information with the payment card number allows for a ticketless lottery transaction.

36. The method of claim 30, wherein associating the lottery purchase information with the payment card number allows for automatic lottery redemption.

37. The method of claim 30, wherein redemption is conducted only with the payment card number.

38. The method of claim 37, wherein redemption is initiated without requiring one of a user's bank information, a user name, and a user's address.

39. The method of claim 30, wherein associating the lottery purchase information with the payment card number allows for lottery redemption without a user providing a bearer instrument.

40. The method of claim 30, further comprising matching the payment card number with lottery purchase information previously stored at the gaming facilitator system.

41. The method of claim 30, further comprising:
receiving lottery winner information from the gaming partner;
determining a winning payment card number associated with the lottery winner information by querying the transaction database; and
providing instructions to a processor to deposit winning funds into an account corresponding to the winning payment card number.

42. The method of claim 30, wherein the gaming facilitator system comprises one or more gaming partner servers, and further comprising:
generating, at the transaction processing server, game play acceptance information at the one or more gaming partner servers.

43. The method of claim 30, wherein the payment card number is one of a debit card number and a credit card number.

44. The method of claim 30, wherein the gaming facilitator system further comprises a winner detection server and a winner redemption server, and further comprising:
comparing, at the winner detection server, a plurality of lottery purchase information records stored in the transaction database with winning numbers received from the gaming partner;
determining, at the winner detection server, whether a minimum number in one or more of the lottery purchase information records matches the winning numbers;
sending a winning lottery purchase information record to the gaming partner for winner validation;
determining, at the winner redemption server, a prize amount to pay;
if the prize amount is less than or equal to an amount allowed for automatic payment, initiating, by winner redemption server, payment of the prize amount to a user account, the user account associated with a winning payment card number associated with the winning lottery purchase information record.

45. The method of claim 44, further comprising:
if the prize amount is not less than or equal to an amount allowed for automatic payment, sending a winner notification to the user.

46. The method of claim 30, wherein the gaming facilitator system further comprises a winner detection server and a winner redemption server, and further comprising:
receiving, at the winner detection server, a list of winning numbers and respective prize amounts from a generic lottery processor;
retrieving, by the winner detection server from the transaction database, for each winning number in the list of winning numbers, a payment card number and lottery purchase information associated with the winning number;
determining, at the winner redemption server, whether the prize amount exceeds an amount allowed for automatic payment;
initiating, at the winner redemption server, payment of the prize amount to a user account, the user account associated with the payment card number associated with the winning number, if the prize amount is less than an amount allowed for automatic payment.

47. The method of claim 46, further comprising recording a redemption authorization number in the transaction database.
